(19) United States
(12) Patent Application Publication
(10) Pub. No.: US 2023/0209686 A1
(43) Pub. Date: Jun. 29, 2023

(54) LIGHT, LIGHT CONTROL DEVICE, LIGHT CONTROL METHOD, AND PROGRAM

(71) Applicant: KYOCERA Corporation, Kyoto (JP)

(72) Inventor: Minako TANI, Yokohama-shi,Kanagawa (JP)

(73) Assignee: KYOCERA Corporation, Kyoto (JP)

(21) Appl. No.: 17/996,475

(22) PCT Filed: Jun. 8, 2021
(86) PCT No.: PCT/JP2021/021801

§ 371 Date: Oct. 18, 2022

(30) Foreign Application Priority Data
Jul. 2, 2020 (JP) 2020-115193

(51) Int. Cl. H05B 47/105; G06Q 50/12

(52) U.S. Cl. CPC H05B 47/105; G06Q 50/12

(57) ABSTRACT

A light control device includes at least one processor configured to control a light associated with a table. The at least one processor controls the light associated with the table based on allergy information about a user who uses the table.

### CROSS-REFERENCE TO RELATED APPLICATIONS

This application claims priority based on Japanese Patent Application No. 2020-115193 filed Jul. 2, 2020, the entire disclosure of which is hereby incorporated by reference.

### TECHNICAL FIELD

The present disclosure relates to a light, a light control device, a light control method, and a program.

### BACKGROUND OF INVENTION

If an allergen is contained in food and drink to be consumed by a person having a food allergy (hereinafter also referred to as an “allergic person” where appropriate), various symptoms may occur in the body due to an overreaction by the immune system. To an allergic person, whether or not a specific food or drink contains a specific allergen is not merely a matter of taste preference, but is a potentially serious problem that could pose a serious health hazard. Accordingly, for businesses and the like that serve food and drink, not serving food and drink containing an allergen to an allergic person is important.

Proposals may be employed to cope with such situations. For example, Patent Literature 1 discloses a method in which the work of comparing allergen information about a plurality of items on a menu with allergen information about a plurality of customers is processed by a computer.

### CITATION LIST

### Patent Literature

Patent Literature 1: Japanese Unexamined Patent Application Publication No. 2019-46232

### SUMMARY

In an embodiment, a light control device includes:

at least one processor configured to control a light associated with a table.

The at least one processor controls the light associated with the table based on allergy information about a user who uses the table.

In an embodiment, a light control device includes:

at least one processor configured to control a light associated with a food or drink.

The at least one processor controls the light associated with the food or drink based on allergy information about a candidate who consumes the food or drink.

In an embodiment, a light control device includes:

at least one processor configured to control a light associated with a food or drink.

The at least one processor controls the light associated with the food or drink based on information about an allergen contained in the food or drink.

In an embodiment, a light includes a light control device as described above.

In an embodiment, a method includes:

controlling a light associated with a table.

The controlling includes controlling the light associated with the table based on allergy information about a user who uses the table.

In an embodiment, a program causes

a computer to execute a process including:

controlling a light associated with a table.

The controlling includes controlling the light associated with the table based on allergy information about a user who uses the table.

### BRIEF DESCRIPTION OF THE DRAWINGS

FIG. 1 is a schematic configuration diagram of a system according to an embodiment.

FIG. 2 is a function block diagram schematically illustrating a configuration of a light control device according to an embodiment.

FIG. 3 is a function block diagram schematically illustrating a configuration of an other electronic device according to an embodiment.

FIG. 4 is a flowchart for describing operations by a light control device according to an embodiment.

FIG. 5A is a diagram illustrating an example of a light controlled by a light control device according to an embodiment.

FIG. 5B is a diagram illustrating an example of a light controlled by a light control device according to an embodiment.

FIG. 5C is a diagram illustrating an example of a light controlled by a light control device according to an embodiment.

FIG. 6 is a flowchart for describing operations by a light control device according to an embodiment.

FIG. 7 is a flowchart for describing operations by a light control device according to an embodiment.

FIG. 8 is a sequence diagram for describing operations by a system according to an embodiment.

FIG. 9 is a schematic configuration diagram of a system according to an embodiment.

FIG. 10 is a function block diagram schematically illustrating a configuration of a display device according to an embodiment.

FIG. 11 is a flowchart for describing operations by a light control device according to an embodiment.

FIG. 12A is a diagram illustrating a display example on a display of a display device according to an embodiment.

FIG. 12B is a diagram illustrating a display example on a display of a display device according to an embodiment.

FIG. 12C is a diagram illustrating a display example on a display of a display device according to an embodiment.

FIG. 13 is a schematic configuration diagram of a system according to an embodiment.

FIG. 14 is a flowchart for describing operations by a light control device according to an embodiment.

### DESCRIPTION OF EMBODIMENTS

In the present disclosure, a “light” may refer to any of various types of members, apparatuses, devices, or the like including a light source. The light may be an incandescent light bulb, a fluorescent light, a light-emitting diode (LED), an organic LED (OLED), inorganic electro-luminescence (EL), optical fiber, or a lamp, for example. The “light” in the present disclosure may be lighting equipment, for example, but is not limited to a member, apparatus, device, or the like to be used for the purpose of illumination. For example, the “light” in the present disclosure may also be used for decorative purposes, and may also be used for the purpose of transmitting information, such as a signal or sign. The “light” in the present disclosure may also be any of various types of members, apparatuses, devices, or the like that output visual information by modulating light without emitting light itself, like a liquid crystal display (LCD), for example. The “light” in the present disclosure may also be, for example, a light filter apparatus that modulates light emitted by another light source. That is, the “light” in the present disclosure may refer to any of various types of members, apparatuses, devices, or the like that output information that is visually recognizable by humans or animals. The “light” in the present disclosure may be an electrically powered member, apparatus, device, or the like. In the present disclosure, the term “light” may signify not only a member, apparatus, or device as described above, but also the “light” outputted from such a member, apparatus, or device.

In the present disclosure, a “light control device” may refer to any of various types of circuits, apparatuses, devices, or the like that control the “light” as described above. For example, as described later, the “light control device” may refer to a dedicated control device for controlling a light. The “light control device” may also refer to an apparatus, device, or the like having a function for controlling a light by being incorporated into a prescribed electronic device, for example. The “light control device” in the present disclosure may be an electrically powered circuit, apparatus, device, or the like. If necessary, the “light control device” in the present disclosure may be configured to receive information from an other electronic device, a terminal of any of various types, or the like. If necessary, the “light control device” in the present disclosure may also be configured to transmit information to an other electronic device, a terminal of any of various types, or the like. Here, the “other electronic device” and “terminal” may refer to any kind of device, such as a server, a dedicated terminal, a computer, a laptop, a tablet, a smartphone, or a mobile phone, for example. The “other electronic device” and “terminal” in the present disclosure may also be an electrically powered device, apparatus, or the like.

The “light” and “light control device” in the present disclosure may be provided for use by a staff member engaged in the work of serving food and drink in a catering establishment or the like, for example. Hereinafter, a business having a staff member engaged in the work of serving food and drink is also simply referred to as the “business”. A staff member engaged in the work of serving food and drink may refer to floor staff such as a waiter or a waitress, or staff such as a sommelier or a garcon. A staff member engaged in the work of serving food and drink may also refer to staff such as a chef, a cook, or a bartender, for example. Hereinafter, a staff member engaged in the work of serving food and drink is also simply referred to as a “catering establishment staff member”.

The “light” and “light control device” in the present disclosure are not limited to being provided for use by a catering establishment staff member. For example, the “light” and “light control device” in the present disclosure may also be provided for use by a person (for example, a customer of the business) who is served food and drink by a catering establishment staff member. A person who is served food and drink may be a visitor who visits a catering establishment, for example. If a visitor who visits a catering establishment uses a table, a chair, and the like at the catering establishment to be served food and drink, the visitor is also referred to as a “user who uses a table”. Hereinafter, a person who is served food and drink by a staff member (catering establishment staff member) engaged in the work of serving food and drink is also simply referred to as the “customer”. The “other electronic device” and “terminal” described above may also be provided for use by a catering establishment staff member in a catering establishment or the like. The “other electronic device” and “terminal” described above may also be provided for use by a person (for example, a user or a customer) who is served food and drink by a catering establishment staff member.

In the present disclosure, one of the “light” or the “light control device” may include the other. That is, an embodiment according to the present disclosure may be carried out as a “light control device” that includes a “light” as described above, or as a “light” that includes a “light control device” as described above.

In the present disclosure, a “display device” refers to any kind of device, such as a dedicated terminal, a tablet, or a smartphone, for example, having a display described later. For instance, the “display device” may refer to a dedicated display apparatus having the display described later. The “display device” in the present disclosure may also be an electrically powered device or apparatus. If necessary, the “display device” in the present disclosure may be configured to receive information from an other electronic device, a terminal of any of various types, or the like. If necessary, the “display device” in the present disclosure may also be configured to transmit information to an other electronic device, a terminal of any of various types, or the like.

The “display device” in the present disclosure may be provided for use by a catering establishment staff member, for example. The “display device” in the present disclosure is not limited to being provided for use by a catering establishment staff member. For example, the “display device” in the present disclosure may be provided for use by a customer, a user who uses a table, or the like.

In the present disclosure, “food and drink” is taken to refer to at least one of food (something to eat) or drink (something to drink). In the present disclosure, a “service for serving food and drink” may refer to a service offered by a business that serves food and drink. Specifically, the “service for serving food and drink” may be thought of as a catering establishment such as a café, a restaurant, or a fast food restaurant, or may be thought of as a business such as a hotel, for example. The “service for serving food and drink” may also include an establishment such as a stall, a food court, or a bar, for example. The “service for serving food and drink” may also include a service that is peripheral to a business that serves food and drink directly, for example. Specifically, the “service for serving food and drink” may also include a service offered by a manufacturer of food and drink or a service offered by a business that delivers food and drink, for example. In the present disclosure, a “customer” may refer to a customer of the service for serving food and drink described above, that is, a person who is served food and drink in the service for serving food and drink described above or the like.

The “light”, “light control device”, and/or “display device” according to the present disclosure can be used in a service for serving food and drink that accommodates an allergy of an allergic person, for example. As described above, an “allergic person” may refer to a person having a food allergy. A person having a food allergy may be thought of as a human being, but may also include an animal such as a pet or livestock, for example. In the present disclosure, a “food allergy” is also referred to as an “allergy”, as appropriate.

Lowering the risk of serving food and drink containing a specific allergen to an allergic person would be beneficial to both the supplier and the consumer of the food and drink. An objective of the present disclosure is to provide a light, a light control device, a light control method, and a program capable of lowering the risk of serving food and drink containing a specific allergen to an allergic person. According to an embodiment, a light, a light control device, a light control method, and a program capable of lowering the risk of serving food and drink containing a specific allergen to an allergic person can be provided. Hereinafter, a system according to an embodiment will be described with reference to the drawings.

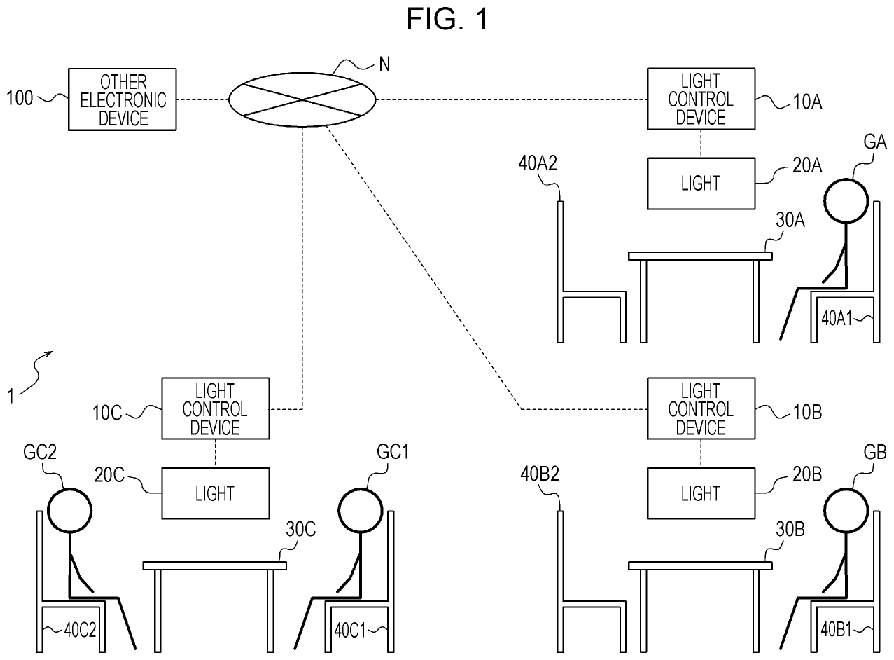

FIG. 1 is a diagram illustrating a configuration of a system according to an embodiment. As illustrated in FIG. 1, in an embodiment, a system 1 may include a light control device 10, a light 20, and an other electronic device 100.

The system 1 illustrated in FIG. 1 includes a light control device 10A, a light control device 10B, and a light control device 10C as light control devices 10. In the present disclosure, light control devices such as the light control device 10A, the light control device 10B, and the light control device 10C may simply be referred to as the “light control device 10” when not being distinguished particularly. The system 1 illustrated in FIG. 1 includes three light control devices 10. However, in an embodiment, the system 1 may include any number of at least one light control device 10. That is, in an embodiment, the system 1 may include only one light control device 10 or more than three light control devices 10.

The system 1 illustrated in FIG. 1 includes a light 20A, a light 20B, and a light 20C as lights 20. In the present disclosure, lights such as the light 20A, the light 20B, and the light 20C may simply be referred to as the “light 20” when not being distinguished particularly. As described above, the light 20 can take a wide variety of configurations. That is, the light 20 may be any of various types of members, apparatuses, devices, or the like that output information that is visually recognizable by humans or animals. Specific examples of the light 20 are given above, and therefore a more detailed description is omitted. The system 1 illustrated in FIG. 1 includes three lights 20. However, in an embodiment, the system 1 may include any number of at least one light 20. That is, in an embodiment, the system 1 may include only one light 20 or more than three lights 20.

The light 20 is controlled by the light control device 10. The light control device 10A may be connected to the light 20A in a wired and/or wireless way to control the light 20A. The light control device 10B may be connected to the light 20B in a wired and/or wireless way to control the light 20B. The light control device 10C may be connected to the light 20C in a wired and/or wireless way to control the light 20C. In the system 1 illustrated in FIG. 1, each light control device 10 is assumed to control a single light 20 connected to itself in a wired and/or wireless way. For this reason, in the system 1 illustrated in FIG. 1, the number of light control devices 10 is the same as the number of lights 20. However, a single light control device 10 may also control multiple lights 20. In this case, the single light control device 10 may be connected to the multiple lights 20 in a wired and/or wireless way.

The system 1 illustrated in FIG. 1 includes one other electronic device 100. In an embodiment, the system 1 may include a plurality of other electronic devices 100. In an embodiment, the system 1 does not necessarily include the other electronic device 100 if the light control device 10 is capable of independent control. As illustrated in FIG. 1, the light control device 10 and the other electronic device 100 may be connected in a wired or wireless way over a network N. In FIG. 1, the possibility of a wired or wireless connection between elements is indicated by a dashed line.

The network N illustrated in FIG. 1 may be wired, wireless, or any combination of wired and wireless connections. The network N may be any network, such as the Internet or an intranet, that enables light control devices 10 to communicate with each other or enables the light control device 10 to communicate with another device such as the other electronic device 100.

As illustrated in FIG. 1, in an embodiment, the light control device 10 and the light 20 may be used in a catering establishment, for example. In a typical catering establishment, a chair, a table, and the like that allow a visitor to take a seat and eat or drink may be available. As an example, the following description assumes a situation in which the light control device 10 and the light 20 according to an embodiment have been adopted in a typical catering establishment.

In a catering establishment where the system 1 illustrated in FIG. 1 has been adopted, suppose that a table 30A, a table 30B, and a table 30C are available as three tables assumed to be used by visitors, for example. In the present disclosure, tables such as the table 30A, the table 30B, and the table 30C may simply be referred to as the “table 30” when not being distinguished particularly. There may be any number of one or more tables 30, depending on factors such as the scale of the catering establishment where the system 1 is adopted, for example.

As illustrated schematically in FIG. 1, chairs 40A1 and 40A2 are placed beside the table 30A, and a user GA who uses the table 30A sits in the chair 40A1. Chairs 40B1 and 40B2 are placed beside the table 30B, and a user GB who uses the table 30B sits in the chair 40B1. Chairs 40C1 and 40C2 are placed beside the table 30C, a user GC1 who uses the table 30C sits in the chair 40C1, and a user GC2 who uses the table 30C sits in the chair 40C2. In the present disclosure, users such as the user GA, the user GB, the user GC1, and the user GC2 may simply be referred to as the “user G” when not being distinguished particularly. In the present disclosure, chairs such as the chair 40A1, the chair 40A2, the chair 40B1, the chair 40B2, the chair 40C1, and the chair 40C2 may simply be referred to as the “chair 40” when not being distinguished particularly.

For example, as illustrated in FIG. 1, the light 20 may be positioned above the table 30. The light 20 may hang down from the ceiling over the table 30, for example. In this case, the light 20 may illuminate food and drink placed on the table 30 and/or the user G who uses the table 30. As another example, the light 20 may also be placed on the table 30 rather than being hung from the ceiling. The light 20 may also be attached to a wall or the like near the table 30, for example. The light 20 may also be placed under the table 30 or on the floor or the like below the table 30, for example. In these cases, the light 20 may or may not illuminate food and drink placed on the table 30 and/or the user G who uses the table 30.

In the system 1 according to an embodiment, each light 20 may be configured such that its relation to each corresponding table 30 is recognizable by at least a staff member on the business side. That is, in FIG. 1, for example, the light 20A may be configured such that its relation to the table 30A (and the user GA who uses the table 30A) is recognizable by at least a staff member of the catering establishment. As another example, in FIG. 1, the light 20B may be configured such that its relation to the table 30B (and the user GB who uses the table 30B) is recognizable by at least a staff member of the catering establishment. As yet another example, in FIG. 1, the light 20C may be configured such that its relation to the table 30C (and the users GC1 and GC2 who use the table 30C) is recognizable by at least a staff member of the catering establishment. In this way, in an embodiment, the light 20 may be associated with the table 30. The light control device 10 may control the light 20 associated with the table 30. The light control device 10 connected to the light 20 may be positioned anywhere insofar as a wired and/or wireless connection to the light 20 is possible.

In the situation illustrated in FIG. 1, the user G sits in the chair 40 placed beside the table 30. However, in certain types of catering establishments, such as places for stand-up eating or stand-up drinking, for example, a counter may be disposed instead of the table 30, and the chair 40 for the user G to sit in is not necessarily available. In this case, an embodiment according to the present disclosure can be applied by substituting “table” with “counter”.

A configuration of each of the light control device 10 and the other electronic device 100 illustrated in FIG. 1 will be described in further detail.

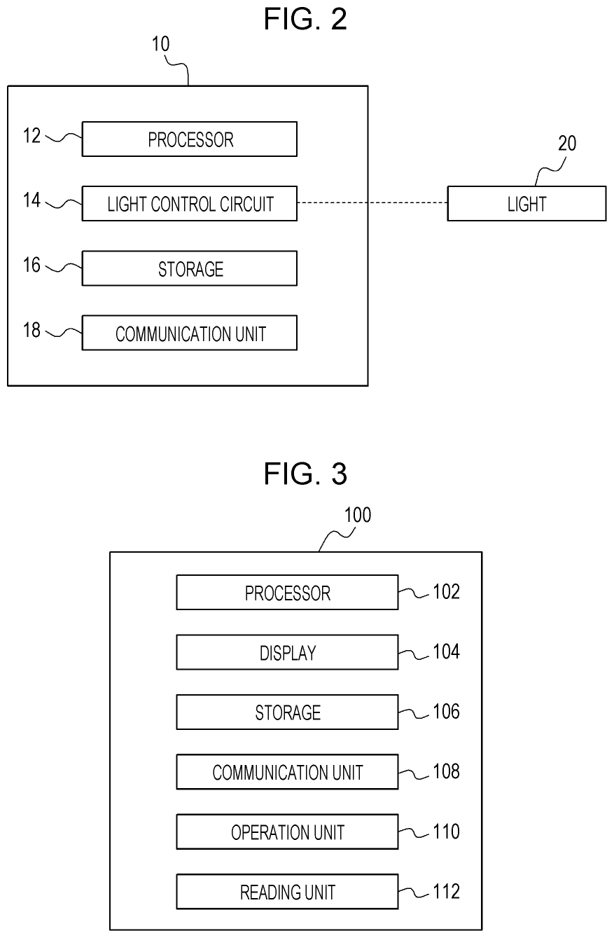

FIG. 2 is a function block diagram schematically illustrating a configuration of the light control device 10 according to an embodiment.

In an embodiment, the light control device 10 may be installed in a catering establishment, for example. As described above, the light control device 10 controls the light 20 by being connected to the light 20 in a wired and/or wireless way. The light control device 10 may be a device designed for a dedicated purpose or may be integrated into another device, for example. In an embodiment, the light control device 10 may be a device provided for use by the customer or a device provided for use by the business. For example, the light control device 10 may act as a device provided for use by the customer and control the light 20 that illuminates the top or the like of the table 30 used by the customer. In another example, the light control device 10 may act as a device provided for use by the customer and control the light 20 that illuminates food and drink placed on top of the table 30 or the like used by the customer. On the other hand, the light control device 10 may also act as a device provided for use by the business and control the light 20 visible to the floor staff, kitchen staff, and/or the like of a catering establishment, for example. Accordingly, the light 20 may be placed where the light 20 can be easily checked by a member of the floor staff or the like who brings food and drink to the user G who uses the table 30.

As illustrated in FIG. 2, in an embodiment, the light control device 10 is provided with a processor 12, a light control circuit 14, a storage 16, and a communication unit 18. In an embodiment, the light control device 10 is not necessarily provided with some of the function units illustrated in FIG. 2, and may also be provided with function units other than those illustrated in FIG. 2.

The processor 12 executes various functions for controlling and/or managing the light control device 10. To provide control and processing power for executing the various functions, the processor 12 may include at least one processor, such as a central processing unit (CPU), for example. The processor 12 may be achieved entirely with a single processor, with several processors, or with respectively separate processors. Here, a “processor” may be achieved as a single integrated circuit. An integrated circuit is also referred to as an IC. The “processor” may be achieved as a plurality of communicably connected integrated circuits and discrete circuits. The “processor” may be achieved based on various other known technologies. In an embodiment, the processor 12 may be configured as a CPU and a program executed by the CPU, for example. A program executed by the processor 12, the result of a process executed by the processor 12, and the like may be stored in the storage 16. The result of a process executed by the processor 12 or the like may also be suggested by the light 20. In an embodiment, the processor 12 controls the light 20 connected to the light control device 10. Here, the light 20 is taken to be associated with the table 30. Operations by the processor 12 of the light control device 10 according to an embodiment will be described in further detail later.

In an embodiment, the processor 12 may be provided with a function for measuring time, like a timer function, for example. The processor 12 may be provided with a function for starting a measurement of time based on a prescribed trigger. The processor 12 may also be provided with a function for starting a measurement of a prescribed time. The processor 12 may be provided with a function for notifying another function unit, for example, about the elapse of the prescribed time.

As illustrated in FIG. 2, the light control circuit 14 controls the light 20 by being connected to the light 20 in a wired and/or wireless way. The light control circuit 14 may be a circuit that drives the light 20, for example. The light control circuit 14 may also be a circuit that switches the light 20 on or off, for example. The light control circuit 14 may also be a circuit that controls the luminance, luminous intensity, and illuminance in addition to the color, blinking mode, and the like of the light 20, for example. The light control circuit 14 may be a circuit that controls a display presented by the light 20. In this way, the light control circuit 14 may be capable of controlling the light 20 in a variety of ways. The light control circuit 14 is not necessarily limited to a circuit that controls the light 20 and may be any function unit that controls the light 20.

The storage 16 stores various information acquired from the processor 12, the communication unit 18, and the like. In an embodiment, the storage 16 may also store information inputted by a user or the like. The storage 16 also stores a program (for example, application software) or the like to be executed by the processor 12. Otherwise, the storage 16 stores various data such as the result of computation by the processor 12, for example. The storage 16 may also include a working memory to be used during operations by the processor 12. The storage 16 can be configured as a semiconductor memory or a magnetic disk, for example, but is not limited to the above and may be any storage apparatus. For example, the storage 16 may be a storage medium such as a memory card inserted into the light control device 10 according to an embodiment. The storage 16 may also be an internal memory of a CPU to be used as the processor 12.

The communication unit 18 is capable of achieving various functions including wireless communication. The communication unit 18 may achieve communication in accordance with any of various communication schemes, such as Long Term Evolution (LTE), 4G, or 5G, for example. The communication unit 18 may include a modem that supports a communication scheme standardized by the International Telecommunication Union Telecommunication Standardization Sector (ITU-T), for example. The communication unit 18 may also achieve wireless communication in accordance with any of various schemes such as Wi-Fi or Bluetooth®, for example. The communication unit 18 may use an antenna, for example, to communicate wirelessly over a network with a communication unit of an external device, such as an external server or a cloud server, for example. In an embodiment, the communication unit 18 may receive various information from an external database in an external server or a cloud server, for example. Information received by the communication unit 18 may be supplied to the processor 12 and/or the storage 16, for example. Information transmitted from the communication unit 18 may be supplied from the processor 12 and/or the storage 16, for example. Information transmitted from the communication unit 18 may be transmitted to the other electronic device 100 or another terminal, for example.

Various information transmitted and received by the communication unit 18 may also be stored in the storage 16, for example. The communication unit 18 may include an antenna for transmitting and receiving radio waves and a suitable RF unit, for example. The communication unit 18 can be configured according to known technology for performing wireless communication. The communication unit 18 may also be an interface for wired communication between the light control device 10 and another device.

In an embodiment, the communication unit 18 of the light control device 10 illustrated in FIG. 2 may communicate in a wired or wireless way with a communication unit 108 (FIG. 3) of the other electronic device 100. The communication unit 18 may also communicate in a wired or wireless way with the communication unit 18 of another light control device 10, for example. In this way, in an embodiment, the communication unit 18 may communicate with another device such as the other electronic device 100, for example. The communication unit 18 may also communicate wirelessly with a communication unit of another device, such as an information processing apparatus that functions as an external server, for example.

In FIG. 1, the light control device 10 is connected to the other electronic device 100 over the network N. However, the light control device 10 may also be connected to the other electronic device 100 without going through the network N. The light control device 10 may also be connected, in a wired or wireless way, to at least one other light control device 10, for example, irrespectively of whether the connection is via the network N.

In an embodiment, the light control device 10 may be a dedicated terminal adapted to the system 1, or a device such as a smartphone, a mobile phone, or a tablet of the related art, for example. If a device such as a smartphone, a mobile phone, or a tablet of the related art is used as the light control device 10, an application to be used in the system 1 may be installed in the light control device 10, for example. The light control device 10 may also be achieved in an Internet browser. In this case, the light control device 10 is not limited to being a smartphone, a mobile phone, a tablet, or the like, and may also be a laptop PC, a desktop PC, or the like.

FIG. 1 illustrates a configuration in which the light control device 10 is connected in a wired and/or wireless way to the light 20 provided separately from the light control device 10. In this case, the light control device 10 and the light 20 may be connected by wireless communication such as short-range wireless communication or training wireless communication, for example. For example, the light control device 10 may be a terminal provided for use by the customer, a terminal provided for use by a staff member or the like of a catering establishment, or a server or the like to be used by the catering establishment. On the other hand, the light control device 10 may also be integrated with the light 20, for example. In this case, as described above, the light control device 10 may have a configuration that includes the light 20 or the light 20 may have a configuration that includes the light control device 10.

FIG. 3 is a function block diagram schematically illustrating a configuration of the other electronic device 100 according to an embodiment.

In an embodiment, the other electronic device 100 may be a device provided for use by a business, for example. As an example of a device provided for use by a business, the other electronic device 100 may be a server managed by a business that serves food and drink. As another example of a device provided for use by a business, the other electronic device 100 may be a server managed by a business commissioned by a business that serves food and drink. Hereinafter, a server managed by a business that serves food and drink and a server managed by a business commissioned by a business that serves food and drink may be collectively referred to as a “server used by a catering establishment”. As another example of a device provided for use by a business, the other electronic device 100 may be a display terminal carried by a member of the floor staff or the like of a catering establishment. As another example of a device provided for use by a business, the other electronic device 100 may be a terminal that a member of the floor staff or the like of a catering establishment can use to input a customer's order. The other electronic device 100 may be a terminal designed for a dedicated purpose or a terminal such as a smartphone or a tablet carried by a member of the floor staff or the like of a catering establishment, for example. As yet another example of a device provided for use by a business, the other electronic device 100 may be a display terminal viewed by a member of the kitchen staff or the like of a catering establishment. In an embodiment, the other electronic device 100 can be thought of as any of various devices that can be viewed when a staff member of a business serves food and drink to a customer. As an example of a device provided for use by a customer, the other electronic device 100 may be a terminal designed for a dedicated purpose or a terminal such as a smartphone or a tablet carried by a visitor who visits a catering establishment.

As illustrated in FIG. 3, in an embodiment, the other electronic device 100 is provided with a processor 102, a display 104, a storage 106, a communication unit 108, an operation unit 110, and a reading unit 112. In an embodiment, the other electronic device 100 is not necessarily provided with some of the function units illustrated in FIG. 3, and may also be provided with function units other than those illustrated in FIG. 3.

Among the function units illustrated in FIG. 3, the processor 102, the storage 106, and the communication unit 108 may be configured based on the same and/or similar concepts as the processor 12, the storage 16, and the communication unit 18, respectively, illustrated in FIG. 2. Among the function units illustrated in FIG. 3, the processor 102, the storage 106, and the communication unit 108 may also be configured based on other concepts, if necessary and as appropriate. A more detailed description of these function units is omitted.

The display 104 may be a display device of any type, such as a liquid crystal display (LCD), an organic electro-luminescence (EL) panel, or an inorganic electro-luminescence (EL) panel, for example. The display 104 may display various types of information such as characters, figures, or symbols. For example, the display 104 may display a menu of food and drink served by a business such as a catering establishment. As another example, the display 104 may display various information such as information pertaining to or associated with food and drink served by a business such as a catering establishment, for example. Information to be displayed on the display 104 may be directed toward a staff member of a business or directed toward a customer. The display 104 may also display objects, icon images, and the like forming various GUI elements, which may include a pointer, for prompting a customer to perform operations. Various data necessary for displaying information on the display 104 may be supplied from the processor 102 or the storage 106, for example. The display 104 may also include a backlight or the like where appropriate.

In an embodiment, the other electronic device 100 may also be provided with a speaker or the like that delivers various information by sound to a staff member and/or a user who operates the other electronic device 100, the speaker or the like being provided instead of, or in addition to, the display 104.

In an embodiment, the display 104 may display the result of a process executed by the processor 102, for example. The display 104 may also display a character, an image, or the like stored in the storage 106, for example. The display 104 may also display a character, an image, or the like based on data received through the communication unit 108, for example. The display 104 may also display information inputted from the operation unit 110, for example.

The operation unit 110 detects an operation as input, the operation being performed by a user, such as a staff member or a customer of a business, for example. The operation unit 110 may be configured as an input device such as a keyboard, for example. The operation unit 110 may be an input device of any type that a user uses to perform operations, such as a key (physical key) like on a keyboard, a button (physical button), a switch (mechanical switch), and/or a pointing device such as a mouse or a trackball, for example. In an embodiment, the operation unit 110 can be any of various known input devices. An operation signal (input signal) detected by the operation unit 110 may be provided to the processor 102 and/or the storage 106, for example.

The operation unit 110 may also be an input device such as a touch panel or a touch sensor. In this case, any of various types of touch panels, such as a resistive touch panel, a capacitive touch panel, or an optical touch panel, may be adopted as the operation unit 110.

In an embodiment, the display 104 may be combined with the operation unit 110 and configured as a touchscreen display, for example. In this case, the touchscreen display may be provided with a display device, such as an LCD display or an organic EL display as the display 104, for example. In this case, the touchscreen display may be provided with a touch sensor or a touch panel that detects the presence and the position of a touch by a user as the operation unit 110, for example. In such a configuration, a key like on a keypad, an icon, or the like may be displayed as an object on the display 104, and an operation performed by an operator (user) touching the object can be detected by the operation unit 110.

The reading unit 112 may include, for example, a barcode reader and/or a camera for reading prescribed identification information that is displayed or printed. In this case, the camera may include any of various types of imaging devices, such as a CCD image sensor, for example. In an embodiment, the reading unit 112 may be configured to read a one-dimensional barcode or a two-dimensional code such as a QR Code® displayed on a display of a terminal carried by a customer, for example. The reading unit 112 may also be configured to read a two-dimensional code such as a QR Code® printed on a coupon or a receipt, for example.

In an embodiment, an identification image to be read by the reading unit 112 is not limited to a one-dimensional code such as a barcode or a two-dimensional code such as a QR Code®, and may be any type of identification image. In an embodiment, the identification information to be read by the reading unit 112 is not limited to image information, either, and may be any type of information, such as a passcode containing a character or a character string, for example. The reading unit 112 is not limited to a function unit such as a barcode reader and/or a camera, and may be an RFID reader or the like that reads identification information from an RF tag, for example. Information read by the reading unit 112 may be supplied to the processor 102 and/or the storage 106, for example.

In an embodiment, the other electronic device 100 may have a hardware configuration that is the same and/or similar to a server in a typical client-server model, for example. In an embodiment, the other electronic device 100 may be a cloud server that provides a cloud service, for example. In the present disclosure, a “server” may refer to a computer that provides a service. That is, a “server” may refer to a computer and/or software that fulfills a function of providing information and/or a processing result in response to a request from a client, like a server in a client-server model, for example.

Operations by the light control device 10 according to an embodiment will be described.

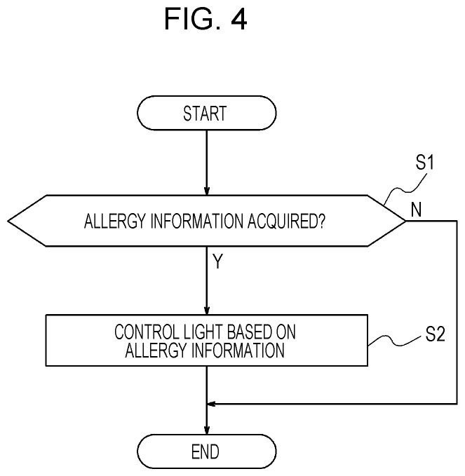

FIG. 4 is a flowchart for describing basic operations by the light control device 10 according to an embodiment. One anticipated situation for performing the operations illustrated in FIG. 4 may be a situation in which the system 1 as illustrated in FIG. 1 has been adopted in a certain catering establishment, for example. Consider a situation in which one light control device 10 is disposed with respect to each of a plurality of tables 30 in the catering establishment, for example. In this case, the other electronic device 100 may be an information processing apparatus that controls and manages the plurality of light control devices 10 in the catering establishment.

In an embodiment, the light control device 10 controls the light 20 to indicate that a customer visiting the catering establishment is an allergic person, for example. In an embodiment, the light control device 10 may also control the light 20 to indicate information related to an allergy of an allergic person.

When the operations illustrated in FIG. 4 are started, the processor 12 of the light control device 10 determines whether allergy information about a customer has been acquired (step S1). In step S1, allergy information about a customer may be acquired from the other electronic device 100, for example. In this situation, the other electronic device 100 may refer to a server used by the catering establishment or an electronic device such as a smartphone carried by the customer, for example. In step S1, allergy information about a customer may be acquired from information stored in the storage 16 of the light control device 10 or from information inputted into the other electronic device 100 via the operation unit 110. Allergy information will be described in further detail later. In step S1, if allergy information has been acquired, the processor 12 controls the light 20 connected to the light control device 10 based on the acquired allergy information (step S2). The specific control of the light 20 executed in step S2 will be described in further detail later.

On the other hand, if allergy information has not been acquired in step S1, the processor 12 may skip step S2 and end the operations illustrated in FIG. 4. If the operations illustrated in FIG. 4 are ended, the processor 12 may start the operations illustrated in FIG. 4 again. In this case, the processor 12 may repeat the operations illustrated in FIG. 4 periodically or aperiodically. The processor 12 may also repeat the operations illustrated in FIG. 4 until allergy information is acquired in step S1.

The “allergy information” determined to be acquired or not in step S1 may refer to, for example, information pertaining to an allergy of a specific customer who makes use of a certain service for serving food and drink (hereinafter also referred to as “specific customer allergy information”). Specific customer allergy information may refer to information pertaining to a specific allergen (antigen that causes an allergy), for example. In particular, specific customer allergy information may refer to information indicating an ingredient selected from among the seven specified ingredients (egg, milk, wheat, buckwheat, peanut, shrimp, and crab) that are required to be labeled under the Food Labeling Standards of the Consumer Affairs Agency of Japan, for example. For instance, if the allergy information includes “buckwheat” and “shrimp”, the allergy information thus indicates that the specific customer has an allergy (of some kind) to “buckwheat” and “shrimp”. Specific customer allergy information may also refer to information indicating an item selected from among items (such as the 21 items for which labeling is recommended, for example) equivalent to the specified ingredients according to the Food Labeling Standards of the Consumer Affairs Agency of Japan, for example.

Specific customer allergy information tends not to change greatly in the short term. Consequently, for example, if a specific customer also inputs allergy information when making an online reservation with a catering establishment, the allergy information may be stored in the other electronic device 100. For example, if a specific customer visits a catering establishment without making a reservation, the customer may input allergy information directly into the other electronic device 100, a display device 50 described later, or the like. If a specific customer visits a catering establishment without making a reservation, for example, allergy information inputted by the customer may be stored in the other electronic device 100.

As a simple example, specific customer allergy information may be information indicating only the existence of an allergy of some kind. For example, if specific customer allergy information indicates “allergic”, the specific customer may be determined to be (or aware of being) an allergic person. As another example, if specific customer allergy information does not indicate “allergic”, the specific customer may be determined not to be (or aware of being) an allergic person. As another example, if specific customer allergy information indicates “not allergic”, the specific customer may be determined not to be (or aware of being) an allergic person.

Specific customer allergy information may also include a type of allergy of the customer. A type of allergy of the customer may be a type of allergen item, for example. For instance, if specific customer allergy information includes “buckwheat” and “shrimp” as types of allergies like in the example described above, the specific customer may be determined to be allergic to “buckwheat” and “shrimp”.

Specific customer allergy information may also include a severity of allergy of the customer. A severity of allergy of the customer may be a class (score) of allergy, such as an antibody titer of IgE antibodies, for example. For instance, if specific customer allergy information includes “buckwheat” and “shrimp” as types of allergies like in the example described above, information indicating the severity (class/score) of each type of allergy may also be included.

There are a variety of possible timings for starting the operations illustrated in FIG. 4. For example, the timing for starting the operations illustrated in FIG. 4 may be set to the time when a specific customer visits a catering establishment and takes a seat at a table in the catering establishment. The timing for starting the operations illustrated in FIG. 4 may also be set to the time when a specific customer takes a seat at a table in a catering establishment and then places an order for food and drink. The timing for starting the operations illustrated in FIG. 4 may also be set to any time from when a specific customer places an order for food and drink until the ordered food and drink is served.

For example, if allergy information about a specific customer is acquired before ordered food and drink is served, the light control device 10 controls the light 20 associated with the table 30 used by the customer based on the allergy information. For example, if the customer provides input indicating “allergic”, the light control device 10 indicates that the customer is allergic through control of the light 20. As another example, if the customer inputs “buckwheat” and “shrimp” as types of allergies, the light control device 10 indicates that the customer is allergic to “buckwheat” and “shrimp” through control of the light 20. As yet another example, if the customer inputs the severity of allergy, the light control device 10 also indicates the severity of allergy through control of the light 20.

The allergy information about a customer described above is not limited to information about a single customer and may also be information about multiple customers. For example, consider a situation in which one light 20 is associated with one table 30, and the one table is used by three customers. Assume that, for example, the light control device 10 connected to the light 20 associated with the one table acquires allergy information indicating “allergic” from two of the customers, and acquires allergy information indicating “allergic” from one of the customers. In this case, the light control device 10 may indicate that allergic persons are present among the three customers through control of the light 20. In this case, the light control device 10 may also indicate “allergic: 2 persons” and/or “not allergic: 1 person” through control of the light 20. In the same and/or a similar way as the example described above, the light control device 10 may also indicate the type of allergy and/or the severity of allergy for each customer through control of the light 20. The light control device 10 may also control the light 20 in accordance with the positions of the customers at the table 30. For example, the light control device 10 may control the light 20 to suggest the positions of the customers at the table 30.

In this way, in an embodiment, the light control device 10 may be provided with at least one processor 12 for controlling the light 20 associated with the table 30. The at least one processor 12 controls the light 20 associated with the table 30 based on allergy information about a user who uses the table 30.

According to an embodiment, a staff member who carries ordered food and drink to a customer can look at the light 20 associated with the table 30 of the customer to easily check whether the food and drink about to be served is safe for the customer. Consequently, according to the light control device 10 and/or the light 20, the risk of serving food and drink containing a specific allergen to an allergic person can be lowered.

Hereinafter, more specific embodiments of the light control device 10 and/or the light 20 described above will be described further.

### First Embodiment

Allergy information about an allergic person may also be considered to fall under “information about an individual” in the Personal Information Protection Act of Japan. For this reason, from the standpoint of protecting privacy, keeping allergy information recognizable to anyone at all times is assumed to be undesirable. In a first embodiment, the light control device 10 and the light 20 indicate allergy information in a way that is difficult to perceive by someone other than a staff member of a catering establishment. Hereinafter, the light control device 10 and the light 20 according to the first embodiment will be described further.

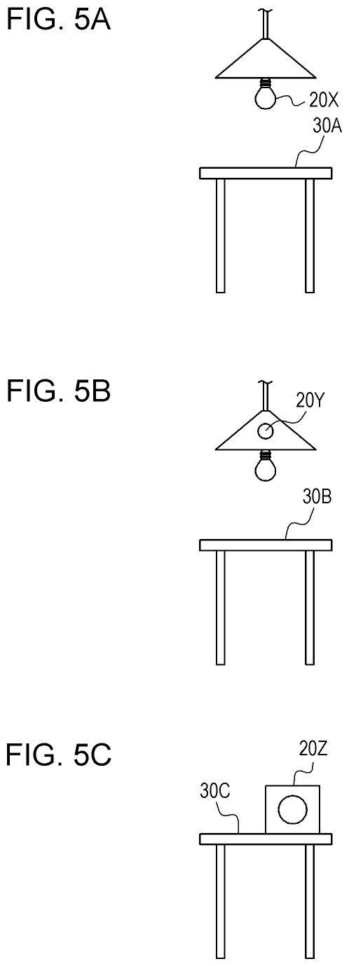

FIGS. 5A to 5C are diagrams illustrating specific examples of the light 20 associated with the table 30 in a catering establishment.

FIG. 5A illustrates a light 20X as an example of the light 20 associated with a table 30A. As illustrated in FIG. 5A, the light 20X may be lighting equipment such as a lamp hanging down from the ceiling over the table 30A, for example. In this case, for example, the light control device 10 may turn on the light 20X associated with the table 30A based on allergy information about a user who uses the table 30A.

FIG. 5B illustrates a light 20Y as an example of the light 20 associated with a table 30B. As illustrated in FIG. 5B, the light 20Y may be a light source for transmitting a signal or sign, the light source being attached to lighting equipment such as a lamp hanging down from the ceiling over the table 30B, for example. In this case, for example, the light control device 10 may turn on the light 20Y associated with the table 30B based on allergy information about a user who uses the table 30B.

FIG. 5C illustrates a light 20Z as an example of the light 20 associated with a table 30C. As illustrated in FIG. 5C, the light 20Z may be lighting equipment such as a lamp placed on the table 30B, for example. In this case, for example, the light control device 10 may turn on the light 20Z associated with the table 30C based on allergy information about a user who uses the table 30C.

FIG. 5 illustrates examples in which one light 20X, light 20Y, and light 20Z is installed in a single piece of lighting equipment, but one or more lights 20X, lights 20Y, or lights 20Z may be installed in a single piece of lighting equipment. For example, when one or more lights 20X are installed in a single piece of lighting equipment, the light control device 10 may control the one or more lights 20X as described above in association with each of one or more tables 30A. More specifically, when a single piece of lighting equipment is provided with at least a first light 20X and a second light 20X, the light control device 10 may control the light 20X in association with a first table 30A and control the second light 20X in association with a second table 30A. That is, the light control device 10 may turn on only the first light 20X of the first light 20X and the second light 20X based on allergy information about a user who uses the first table 30A. The light control device 10 may also turn on both lights 20X of the first light 20X and the second light 20X based on allergy information about a user who uses the first table 30A and allergy information about a user who uses the second table 30A, respectively. This specific example illustrates a case where one or more lights 20X are installed in a single piece of lighting equipment, but the light 20X may be replaced with the light 20Y or the light 20Z and the table 30A may be replaced with the table 30B or the table 30C. In this case, the above can be treated as an example of installing one or more lights 20Y in a single piece of lighting equipment or one or more lights 20Z in a single piece of lighting equipment.

In the case of using the light control device 10 and the light 20 as above, a staff member of a catering establishment may understand in advance the meaning of the light 20 being on. For example, the light 20 being on may be taken to mean that a user of the table 30 corresponding to the light 20 is an allergic person. On the other hand, for example, the light 20 being on may be taken to mean that a user of the table corresponding to the light 20 is not an allergic person. With this arrangement, a staff member of a catering establishment can recognize that the light 20 is on and thereby easily grasp whether a user who uses the table 30 is an allergic person.

In this way, the at least one processor 12 may turn on the light 20 associated with the table 30 based on allergy information about the user G who uses the table 30.

According to the first embodiment, for example, a staff member who carries ordered food and drink to a customer can look at the light 20 associated with the table 30 of the customer to check whether the food and drink is safe for the customer. According to the first embodiment, a person other than a staff member of the catering establishment, such as a general visitor who visits the catering establishment, for example, will not be able to look at the light 20 and easily understand that allergy information is being indicated. Consequently, according to the light control device 10 and/or the light 20 according to the first embodiment, safe food and drink can be served to a customer while also protecting the privacy of the customer.

In the first embodiment, the means for indicating whether a user who uses the table 30 is an allergic person is not limited to turning on the light 20.

For example, the light control device 10 may also indicate whether a user who uses the table 30 is an allergic person by changing a light emission mode of the light 20 associated with the table 30. Specifically, the light control device 10 may indicate whether a user who uses the table 30 corresponding to the light 20 is an allergic person by changing at least one selected from the group consisting of the luminance, luminous intensity, and illuminance of the light 20. For example, the light control device 10 may indicate that a user who uses the table 30 is or is not an allergic person by brightening or darkening the light 20 to some degree.

Specifically, the light control device 10 may indicate whether a user who uses the table 30 corresponding to the light 20 is an allergic person by changing the color of the light 20. For example, the light control device 10 may indicate that a user who uses the table 30 is not an allergic person by changing the light 20 to a blue color. On the other hand, the light control device 10 may indicate that a user who uses the table 30 is an allergic person by changing the light 20 to a yellow color.

Specifically, the light control device 10 may indicate whether a user who uses the table 30 corresponding to the light 20 is an allergic person by causing the light 20 to blink. For example, the light control device 10 may indicate that a user who uses the table 30 is or is not an allergic person by causing the light 20 to blink. The light control device 10 may also indicate that a user who uses the table 30 is or is not an allergic person by changing the color and/or speed at which the light 20 is made to blink.

In this way, the at least one processor 12 may change the light emission mode of the light 20 associated with the table 30. For example, the at least one processor 12 may change at least one selected from the group consisting of the luminance, the luminous intensity, and the illuminance of the light 20 associated with the table 30. For example, the at least one processor 12 may change the color of the light 20 associated with the table 30. For example, the at least one processor 12 may cause the light 20 associated with the table 30 to blink. In cases like the above, the light 20 may be turned on initially, or the light 20 that is off initially may be turned on at the same time as a change like the above is made.

In some situations, multiple people may use a single table 30, like the users GC1 and GC2 who use the table 30C illustrated in FIG. 1, for example. In such cases, the allergy information acquired in step S1 illustrated in FIG. 4 may include allergy information about multiple users who use the table 30. If allergy information about multiple users is included, the light control device 10 may change the light emission mode of the light 20 to be different from the case where allergy information about a single user is included. For example, the light control device 10 may cause the color of the light 20 to be different between the case where multiple users are allergic persons and the case where multiple users are allergic persons. The light control device 10 may also cause a blinking mode of the light 20 to be different between the case where multiple users are allergic persons and the case where multiple users are allergic persons.

In this way, the allergy information may include allergy information about multiple users who use the table 30. In this case, the at least one processor 12 may change the light emission mode of the light 20 associated with the table 30 to be different from the case where the allergy information includes only allergy information about a single user who uses the table 30.

### Second Embodiment

When a staff member carrying ordered food and drink places the food and drink on the customer's table, the ability to easily recognize allergy information about the customer is desirable. As described above, allergy information about a customer may be information indicating the existence of an allergy, and may also be information including the type of allergy and/or the severity of allergy. According to a second embodiment, the light control device 10 and the light 20 display various allergy information about a customer in an easily recognizable way. In the second embodiment, the light control device 10 and the light 20 also indicate allergy information in a way that is difficult to perceive by someone other than a staff member of a catering establishment, in the same and/or a similar way as the first embodiment. Hereinafter, the light control device 10 and the light 20 according to the second embodiment will be described further.

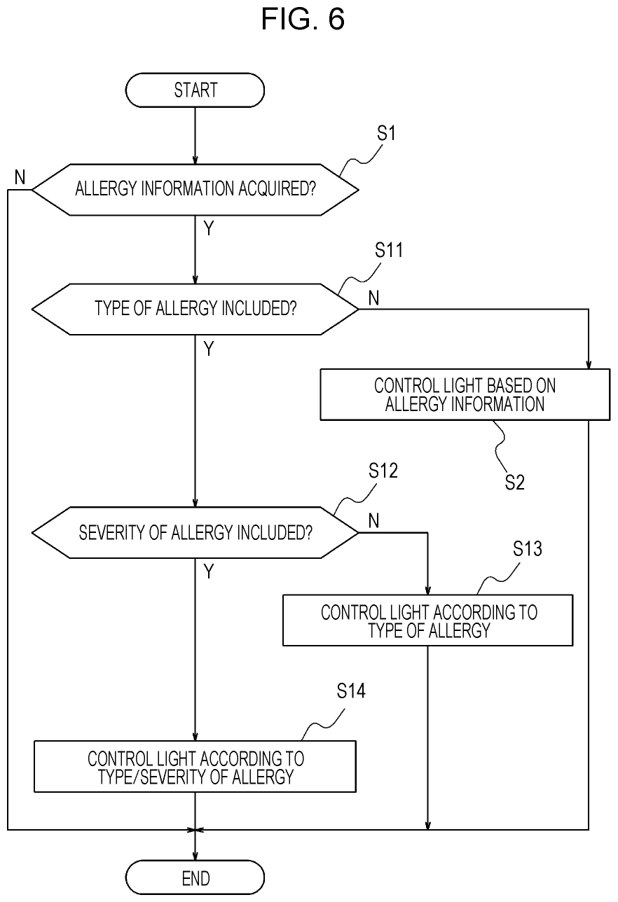

FIG. 6 is a flowchart for describing operations by the light control device 10 according to the second embodiment. The light control device 10 and the light 20 according to the second embodiment may be thought of as the same and/or similar to the light control device 10 and the light 20 according to the first embodiment. For example, in the second embodiment, the light control device 10 may control the light 20 associated with the table 30 used by a customer of a service for serving food and drink. Here, the customer of the service for serving food and drink may be a user who uses the table 30.

When the operations illustrated in FIG. 6 are started, the processor 12 of the light control device 10 determines whether allergy information about a customer has been acquired (step S1), in the same and/or a similar way as step S1 illustrated in FIG. 4. If allergy information has not been acquired in step S1, the processor 12 may end the operations illustrated in FIG. 6. If the operations illustrated in FIG. 6 are ended, the processor 12 may start the operations illustrated in FIG. 6 again. In this case, the processor 12 may repeat the operations illustrated in FIG. 6 periodically or aperiodically. The processor 12 may also repeat the operations illustrated in FIG. 6 until allergy information is acquired in step S1.

In step S1, if allergy information has been acquired, the processor 12 determines whether the acquired allergy information includes a type of allergy (step S11). If the allergy information is determined not to include a type of allergy in step S11, the processor 12 controls the light 20 based on the acquired allergy information (step S2).

In step S2, the processor 12 may control the light 20 to indicate whether the user who uses the table 30 is an allergic person. For example, the processor 12 may indicate whether the user who uses the table 30 is an allergic person by putting the light 20 into a light-emitting/non-light-emitting state. The process in step S2 illustrated in FIG. 6 may be performed based on the same and/or similar concept as step S2 illustrated in FIG. 4. After step S2, the processor 12 may end the operations illustrated in FIG. 6.

On the other hand, if the allergy information is determined to include a type of allergy in step S11, the processor 12 determines whether the allergy information includes a severity of allergy (step S12). If the allergy information is determined not to include a severity of allergy in step S12, the processor 12 controls the light 20 according to the type of allergy (step S13).

In the case of proceeding to step S13, the allergy information about the customer is information that includes a type of allergy but does not include a severity of allergy. Consequently, in step S13, the processor 12 may control the light 20 according to the type of allergy of the user who uses the table 30.

As an example, consider a situation in which the allergy information about the user who uses the table 30 includes “shrimp”, “egg”, and “wheat” as types of allergies. In other words, assume that a customer visiting a certain catering establishment has inputted allergy information including the types of allergies “shrimp”, “egg”, and “wheat” as the customer's own allergy information.

In this case, the processor 12 may control the light 20 such that the light 20 suggests allergies to “shrimp”, “egg”, and “wheat”. For example, the processor 12 may control the light 20 such that light sources corresponding to “shrimp”, “egg”, and “wheat” turn on in the light 20. The processor 12 may also control the light 20 such that the light 20 turns on with a brightness corresponding to “shrimp”, “egg”, and “wheat”. The processor 12 may also control the light 20 such that the light 20 turns on with a color corresponding to “shrimp”, “egg”, and “wheat”. The processor 12 may also control the light 20 such that the light 20 blinks in a mode (for example, a speed or a pattern) corresponding to “shrimp”, “egg”, and “wheat”.

In this way, in the present embodiment, allergy information may include a type of allergy of a user who uses the table 30. In this case, the at least one processor 12 may control the light 20 associated with the table 30 according to the type of allergy. For example, the at least one processor 12 may change at least one selected from the group consisting of the luminance, the luminous intensity, and the illuminance of the light 20 associated with the table 30 according to the type of allergy. As another example, the at least one processor 12 may change the color of the light 20 associated with the table 30 according to the type of allergy. As another example, the at least one processor 12 may change the blinking mode of which the light 20 associated with the table 30 according to the type of allergy.

According to the second embodiment, a staff member who carries ordered food and drink to a customer can look at the light 20 associated with the table 30 of the customer to easily recognize allergy information about the customer, including the type of allergy. For instance, in the example described above, a staff member who carries food and drink to a customer can look at the light 20 associated with the table 30 of the customer to recognize that the customer is allergic to shrimp, egg, and wheat.

On the other hand, if the allergy information is determined to include a severity of allergy in step S62 illustrated in FIG. 6, the processor 12 controls the light 20 according to the severity of allergy and the severity of allergy (step S14).

In the case of proceeding to step S14, the allergy information about the customer is information that includes a type of allergy and a severity of allergy. Consequently, in step S14, the processor 12 may control the light 20 to indicate the severity of allergy for each type of allergy of the customer, for example.

As an example, consider a situation in which the allergy information about the user who uses the table 30 includes “shrimp”, “egg”, and “wheat” as types of allergies. Consider a situation in which the allergy information about the user includes information indicating class 1 for “shrimp”, class 2 for “egg”, and class 4 for “wheat” as the severities of allergies, for example. In other words, assume that a customer visiting a certain catering establishment has inputted allergy information including the types and severities of allergies “shrimp” (class 1), “egg” (class 2), and “wheat” (class 4) as the customer's own allergy information.

In this case, the processor 12 may control the light 20 such that the light 20 suggests allergies to “shrimp”, “egg”, and “wheat” along with the severity of each. For example, the processor 12 may control the light 20 such that light sources corresponding to “shrimp”, “egg”, and “wheat” turn on in the light 20. At this time, the processor 12 may control the light 20 to indicate the severity of each corresponding allergy depending on the position where the light sources indicating “shrimp”, “egg”, and “wheat” turn on in the light 20. As another example, the processor 12 may control the light 20 to indicate the severity of each corresponding allergy depending on the brightness at which the light sources indicating “shrimp”, “egg”, and “wheat” turn on in the light 20. As another example, the processor 12 may control the light 20 to indicate the severity of each corresponding allergy depending on the color with which the light sources indicating “shrimp”, “egg”, and “wheat” turn on in the light 20. As yet another example, the processor 12 may control the light 20 to indicate the severity of each corresponding allergy depending on the mode (for example, a speed or a pattern) in which the light sources indicating “shrimp”, “egg”, and “wheat” blink in the light 20.

In this way, in the present embodiment, allergy information may include a severity of allergy of a user who uses the table 30. In this case, the at least one processor 12 may control the light 20 associated with the table 30 according to the severity of allergy. For example, the at least one processor 12 may change at least one selected from the group consisting of the luminance, the luminous intensity, and the illuminance of the light 20 associated with the table 30 according to the severity of allergy. As another example, the at least one processor 12 may change the color of the light 20 associated with the table 30 according to the severity of allergy. As another example, the at least one processor 12 may change the blinking mode of the light 20 associated with the table 30 according to the severity of allergy.

According to the second embodiment, a staff member who carries ordered food and drink to a customer can look at the light 20 associated with the table 30 of the customer to easily recognize allergy information about the customer, including the type and severity of allergy. For instance, in the example described above, a staff member who carries food and drink to a customer can look at the light 20 associated with the table 30 of the customer to recognize that the customer is allergic to shrimp, egg, and wheat, and also recognize the severities of the allergies. Consequently, according to the light control device 10 and/or the light 20 according to the second embodiment, the risk of serving food and drink containing a specific allergen to an allergic person can be lowered.

In the second embodiment, the light control device 10 can, through control of the light 20, display various allergy information about a customer in a visually recognizable way. In another embodiment, the light control device 10 may also present various allergy information about a customer in an aurally recognizable way through the output of sound or speech, instead or in addition to the control of the light 20.

(Start Timing of Control by Light Control Device 10)

The timings at which the control by the light control device 10 is started in the first and second embodiments above will be described.

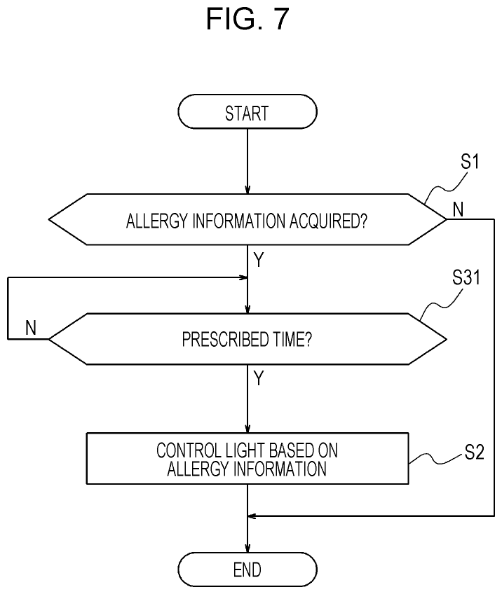

FIG. 7 is a flowchart for describing operations by the light control device 10 according to an embodiment.

The operations by the light control device 10 illustrated in FIG. 7 are the operations illustrated in FIG. 4 with the addition of step S31 between steps S1 and S2. Consequently, a description of content that is the same as the content described in FIG. 4 will be simplified or omitted, as appropriate.

In the operations illustrated in FIG. 4, the processor 12 of the light control device 10 acquires allergy information (step S1) and controls the light 20 based on the allergy information (step S2). In contrast, in the operations illustrated in FIG. 7, when allergy information is acquired in step S1, the processor 12 of the light control device 10 determines whether the time has reached a prescribed time (step S31). If the prescribed time has not been reached in step S31, the processor 12 stands by without performing the process in step 2. On the other hand, if the prescribed time has been reached in step S31, the processor 12 controls the light 20 based on the allergy information (step S2).

In the operations illustrated in FIG. 7, the “prescribed time” may be any of various timings. For example, the prescribed time may be the time when a customer specified by the allergy information acquired in step S1 visits the catering establishment where the light control device 10 and the light 20 have been adopted. For example, if the customer made a reservation with the catering establishment in advance, the reservation time may be treated as the “prescribed time”. In the case where the customer makes a reservation with the catering establishment on the web, a server (other electronic device 100) used by the catering establishment may designate the reserved time as the prescribed time in a notification to the light control device 10. In the case where the customer makes a reservation with the catering establishment over the phone, a person at the catering establishment who takes the reservation phone call may input the scheduled visit time of the reservation into the other electronic device 100.

In this way, the at least one processor 12 may start execution of the control of the light 20 associated with the table 30 at a prescribed time (timing).

(Allowing/Disallowing Control by Light Control Device 10)

Allowing/disallowing the control by the light control device 10 in the first and second embodiments above will be described.

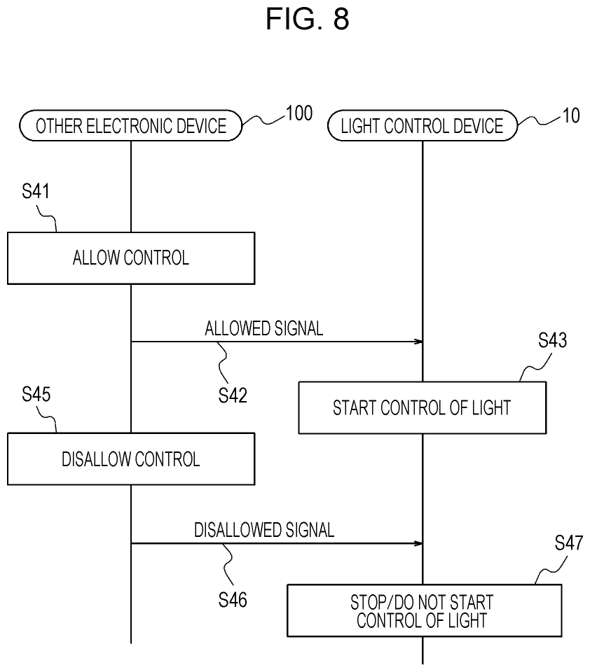

FIG. 8 is a sequence diagram for describing operations by the light control device 10 and the other electronic device 100 included in the system 1 according to an embodiment. In particular, FIG. 8 mainly illustrates an exchange between the light control device 10 and the other electronic device 100.

In the following description, operations to be executed by the “light control device 10” may be taken to mean operations performed by having the processor 12 of the light control device 10 control a related function unit. Likewise, operations to be executed by the “other electronic device 100” may be taken to mean operations performed by having the processor 102 of the other electronic device 100 control a related function unit.

The time at which the operations illustrated in FIG. 8 are started may be the time at which the other electronic device 100 acquires allergy information about a user who uses the table 30 corresponding to the light 20. For example, if a specific customer also inputs allergy information when making an online reservation with a catering establishment, the other electronic device 100 may store the allergy information in the storage 106. The other electronic device 100 may also store, in the storage 106, allergy information received through the communication unit 108 or the reading unit 112 from an electronic device such as a smartphone carried by the customer. As another example, if a specific customer visits a catering establishment without making a reservation, the other electronic device 100 may store, in the storage 106, allergy information input that the customer inputs directly into a terminal installed at a table. If a specific customer visits a catering establishment without making a reservation, the other electronic device 100 may also store, in the storage 106, allergy information input that a staff member of the catering establishment inputs when taking the customer's order or the like.

Assume that after the operations illustrated in FIG. 8 start, the other electronic device 100 allows execution of the control by the light control device 10 (step S41). In step S41, the other electronic device 100 may allow execution of the control by the light control device 10 based on any of various triggers. For example, if a customer reservation is registered, the other electronic device 100 may allow execution of the control by the light control device 10 when triggered by the current time reaching the reservation time. The other electronic device 100 may also allow execution of the control by the light control device 10 when triggered by customer entering the premises of the catering establishment, for example. The other electronic device 100 may also allow execution of the control by the light control device 10 when triggered by customer ordering food and drink on the premises of the catering establishment, for example. The other electronic device 100 may also allow execution of the control by the light control device 10 when triggered by the completion of the preparation of food and drink ordered by the customer, for example.

If execution of the control by the light control device 10 is allowed in step S41, the other electronic device 100 transmits an allowed signal to the light control device 10 through the communication unit 108 or the like (step S42). If the allowed signal is transmitted in step S42, the light control device 10 receives the allowed signal through the communication unit 18 or the like. If the allowed signal transmitted in step S42 is received, the light control device 10 may start the control of the light 20 associated with the table 30 (step S43).

In this way, the light control device 10 may be provided with a reception unit (communication unit 18) that receives, from the other electronic device 100, an allowed signal allowing execution of the control of the light 20 associated with the table 30. In this case, the at least one processor 12 may start execution of the control of the light 20 associated with the table 30 if the communication unit 18 receives the allowed signal.

On the other hand, assume that after the operations illustrated in FIG. 8 start, the other electronic device 100 disallows execution of the control by the light control device 10 (step S45). In step S45, the other electronic device 100 may disallow execution of the control by the light control device 10 based on any of various triggers. For example, if a customer reservation is registered, the other electronic device 100 may disallow execution of the control by the light control device 10 when triggered by the current time reaching a prescribed time elapsing from the reservation time. The other electronic device 100 may also disallow execution of the control by the light control device 10 when triggered by customer exiting the premises of the catering establishment, for example. The other electronic device 100 may also disallow execution of the control by the light control device 10 when triggered by the food and drink ordered by the customer being brought to the table 30, for example. The other electronic device 100 may disallow execution of the control by the light control device 10 when triggered by the completion of settling the bill for the food and drink served to the customer.

If execution of the control by the light control device 10 is disallowed in step S45, the other electronic device 100 transmits a disallowed signal to the light control device 10 through the communication unit 108 or the like (step S46). If the disallowed signal is transmitted in step S46, the light control device 10 receives the disallowed signal through the communication unit 18 or the like. If the disallowed signal transmitted in step S46 is received, the light control device 10 may stop the control of the light 20 associated with the table 30 if the control has been started (step S47). In step S47, if the control of the light 20 associated with the table 30 has not been started, the light control device 10 may keep the control non-started.

In this way, the light control device 10 may be provided with a reception unit (communication unit 18) that receives, from the other electronic device 100, a disallowed signal disallowing execution of the control of the light 20 associated with the table 30. In this case, the at least one processor 12 does not start or stops execution of the control of the light 20 associated with the table 30 if the communication unit 18 receives the disallowed signal.

### Third Embodiment

In each of the embodiments described above, from the standpoint of protecting privacy, for example, the light control device 10 and the light 20 indicate allergy information in a way that is difficult to perceive by someone other than a staff member of a catering establishment. On the other hand, indicating allergy information about a customer in a way that is more intuitive and easy to recognize to a staff member of a catering establishment or the like may be desirable in some cases. For example, when a staff member carrying ordered food and drink places the food and drink on the table 30 of the customer, the ability to easily recognize allergy information about the customer is desirable. As described above, allergy information about a customer may be information indicating the existence of an allergy, and may also be information including the type of allergy and/or the severity of allergy. According to a third embodiment, the light control device 10 indicates allergy information about a customer in a way that is more intuitive and easy to recognize. Hereinafter, the light control device 10 according to the third embodiment will be described further. In the following description, a description of content that is the same as the content already described will be simplified or omitted, as appropriate.

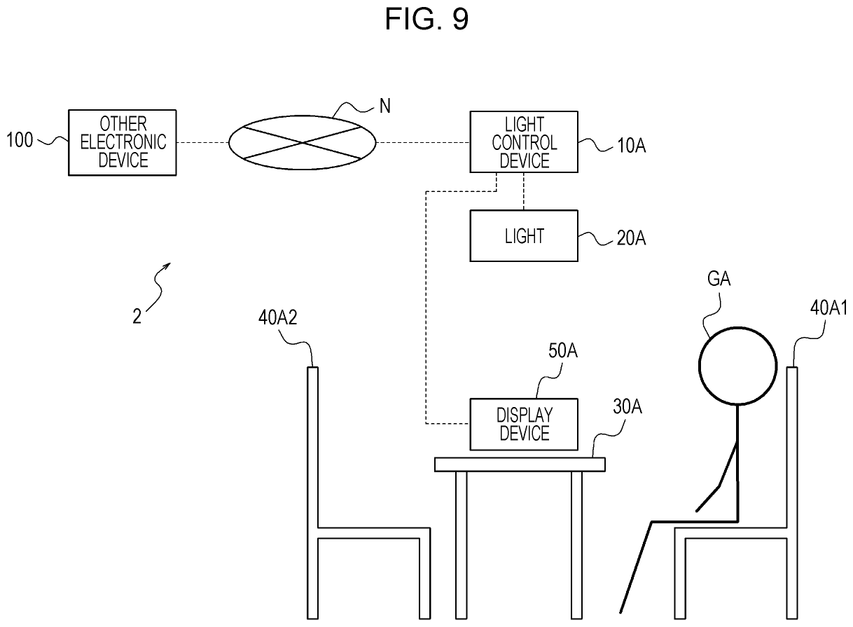

FIG. 9 is a diagram illustrating a configuration of a system according to the third embodiment. As illustrated in FIG. 9, a system 2 according to the third embodiment may further include a display device 50 in the system 1 illustrated in FIG. 1. As illustrated in FIG. 9, in the system 2, the light control device 10A may not only be connected to the light 20A in a wired and/or wireless way, but also connected to a display device 50A in a wired and/or wireless way. The display device 50A may be connected to the other electronic device 100 directly in a wired and/or wireless way.

For simplicity, FIG. 9 illustrates only the display device 50A connected to the light control device 10A. That is, FIG. 9 illustrates only the components related to the user GA, while components related to other users are omitted from illustration. However, in the system 2, the light control device 10B may also be connected to a display device 50B in a wired and/or wireless way, for example. In the system 2, the light control device 10C may also be connected to a display device 50C in a wired and/or wireless way, for example. In the present disclosure, multiple display devices such as the display device 50A, the display device 50B, and the display device 50C may simply be referred to as the “display device 50” when not being distinguished particularly. In an embodiment, the system 2 may include any number of at least one display device 50. That is, in an embodiment, the system 2 may include only one display device 50 or more than three display devices 50.

In the system 2 according to the third embodiment, each display device 50 may be configured such that its relation to each corresponding table 30 is recognizable by at least a staff member on the business side. That is, in FIG. 9, for example, the display device 50A may be configured such that its relation to the table 30A (and the user GA who uses the table 30A) is recognizable by at least a staff member of the catering establishment. The display device 50B may be configured such that its relation to the table 30B (and the user GB who uses the table 30B) is recognizable by at least a staff member of the catering establishment. The display device 50C may be configured such that its relation to the table 30C (and the users GC1 and GC2 who use the table 30C) is recognizable by at least a staff member of the catering establishment. In this way, in an embodiment, the display device 50 may be associated with the table 30. The light control device 10 may control the display device 50 associated with the table 30.

For example, as illustrated in FIG. 9, the display device 50 may be placed on the table 30. The display device 50 may also be positioned above the table 30. The display device 50 may also be attached to a wall or the like near the table 30, for example. The display device 50 may also be placed under the table 30 or on the floor or the like below the table 30, for example.

In the third embodiment, the display device 50 may be a device provided for use by the customer or a device provided for use by the business. As an example of a device provided for use by a customer, the display device 50 may be a terminal device which is placed on a table used by the customer, and on which a menu of food and drink or the like is displayed. As another example of a device provided for use by a customer, the display device 50 may be a terminal that a customer can use on their own to input an order for food and drink. As another example of a device provided for use by a customer, the display device 50 may be a terminal designed for a dedicated purpose or a terminal such as a smartphone or a tablet carried by a customer. On the other hand, as an example of a device provided for use by a business, the display device 50 may be a display terminal carried by a member of the floor staff or the like of a catering establishment. As another example of a device provided for use by a business, the display device 50 may be a terminal that a member of the floor staff or the like of a catering establishment can use to input a customer's order. As another example of a device provided for use by a customer, the display device 50 may be a terminal designed for a dedicated purpose or a terminal such as a smartphone or a tablet carried by the floor staff or the like of a catering establishment. As yet another example of a device provided for use by a business, the display device 50 may be a display terminal viewed by a member of the kitchen staff or the like of a catering establishment. In an embodiment, the display device 50 can be thought of as any of various devices that can be viewed when a staff member of a business serves food and drink to a customer. In the present embodiment, the display device 50 may be any device that is used when a staff member of a service for serving food and drink interacts with a customer of the service for serving food and drink. In an embodiment, the display device 50 may also be based on digital signage technology.

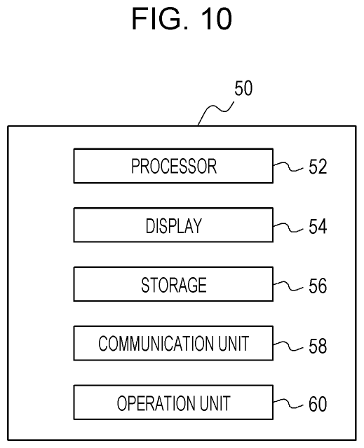

FIG. 10 is a function block diagram schematically illustrating a configuration of the display device 50 according to the third embodiment.

As illustrated in FIG. 10, in an embodiment, the display device 50 is provided with a processor 52, a display 54, a storage 56, a communication unit 58, and an operation unit 60. In an embodiment, the display device 50 is not necessarily provided with some of the function units illustrated in FIG. 10, and may also be provided with function units other than those illustrated in FIG. 10.

The function units illustrated in FIG. 10, that is, the processor 52, the display 54, the storage 56, the communication unit 58, and the operation unit 60, may be configured based on the same and/or similar concepts as the processor 102, the display 104, the storage 106, the communication unit 108, and the operation unit 110, respectively, illustrated in FIG. 3. Each of the function units illustrated in FIG. 10 may also be configured based on other concepts, if necessary and as appropriate. A more detailed description of these function units is omitted.

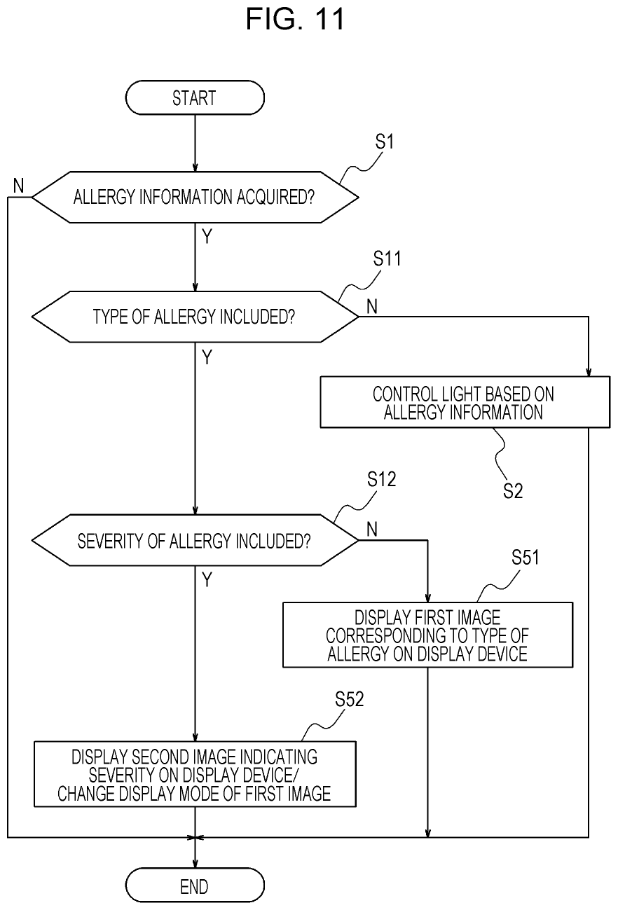

FIG. 11 is a flowchart for describing operations by the display device 50 according to the third embodiment.

The operations illustrated in FIG. 11 are the operations by the light control device 10 according to the second embodiment illustrated in FIG. 6, but with steps S13 and S14 changed to steps S51 and S52, respectively. Otherwise, the operations can be performed in the same and/or a similar way as the operations by the light control device 10 according to the second embodiment illustrated in FIG. 6, and therefore a description of content that is the same will be simplified or omitted, as appropriate.

If the allergy information is determined not to include a severity of allergy in step S12 illustrated in FIG. 11, the processor 12 displays an image corresponding to the type of allergy on the display 54 of the display device 50 (step S51).

In the case of proceeding to step S51, the allergy information about the customer is information that includes a type of allergy but does not include a severity of allergy. Consequently, in step S51, the processor 12 may control the display 54 to display an image corresponding to the type of allergy of the customer. For example, the processor 12 may cause the display 54 to display an image indicating the content of the type of allergy of the customer. Hereinafter, an image indicating the content of the type of allergy of the customer is also referred to as the first image for convenience.

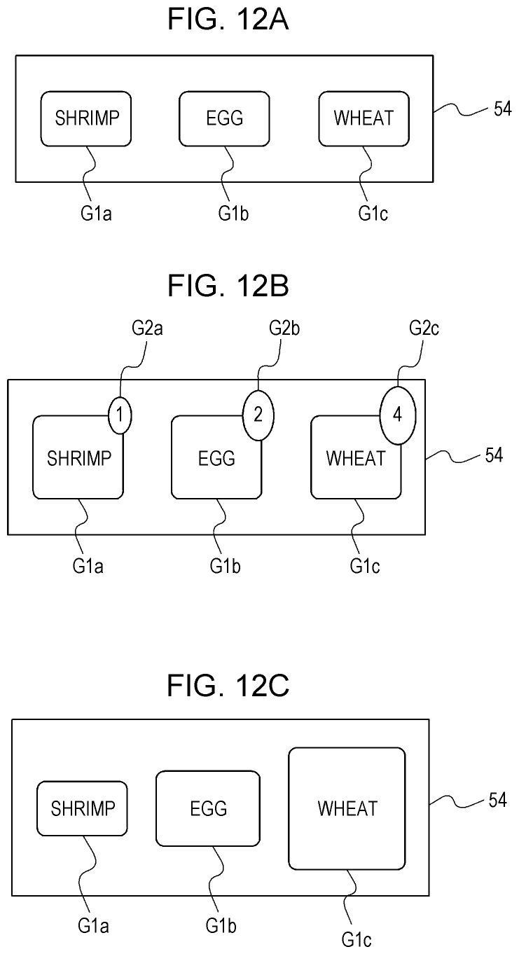

FIG. 12A is a diagram illustrating an example of the display on the display 54 of the display device 50. As an example, consider a situation in which the allergy information about a certain customer includes “shrimp”, “egg”, and “wheat” as types of allergies. In other words, assume that a customer visiting a certain catering establishment has inputted allergy information including the types of allergies “shrimp”, “egg”, and “wheat” as the customer's own allergy information. In this case, as illustrated in FIG. 12A, the processor 12 may control the display 54 to display an image G1a indicating “shrimp”, an image G1b indicating “egg”, and an image G1c indicating “wheat” as the first images. The processor 12 may cause the images G1a, G1b, and G1c to be displayed in the same color or in respectively characteristic colors on the display 54.

In this way, in the present embodiment, allergy information may include a type of allergy of a user who uses the table 30. In this case, the at least one processor 12 may also cause the display device 50 associated with the table 30 to display the first image corresponding to the type of allergy.

According to the third embodiment, a staff member who carries ordered food and drink to a customer can look at the display 54 of the display device 50 placed on the table 30 of the customer to easily recognize allergy information about the customer, including the type of allergy. For instance, in the example illustrated in FIG. 12A, a staff member who carries food and drink to a customer can look at the display 54 of the display device 50 placed on the table 30 of the customer to recognize that the customer is allergic to shrimp, egg, and wheat.

On the other hand, if the allergy information is determined to include a severity of allergy in step S12 illustrated in FIG. 11, the processor 12 displays an image indicating the severity of allergy on the display 54 of the display device 50 (step S52).

In the case of proceeding to step S52, the allergy information about the customer is information that includes a type of allergy and a severity of allergy. Consequently, in step S52, the processor 12 may control the display 54 of the display device 50 to display an image indicating the severity of allergy for each type of allergy of the customer. For example, the processor 12 may cause the display 54 of the display device 50 to display an image indicating the severity of allergy of the customer. Hereinafter, an image indicating the severity of allergy of the customer is also referred to as the second image for convenience.

FIG. 12B is a diagram illustrating an example of the display on the display 54 of the display device 50. As an example, consider a situation in which the allergy information about a certain customer includes “shrimp”, “egg”, and “wheat” as types of allergies. Consider a situation in which the allergy information about the customer includes information indicating class 1 for “shrimp”, class 2 for “egg”, and class 4 for “wheat” as the severities of allergies, for example. In other words, assume that a customer visiting a certain catering establishment has inputted allergy information including the types and severities of allergies “shrimp” (class 1), “egg” (class 2), and “wheat” (class 4) as the customer's own allergy information.

In this case, as illustrated in FIG. 12B, the processor 12 may control the display 54 to display an image G1a indicating “shrimp”, an image G1b indicating “egg”, and an image G1c indicating “wheat” as the first images. Additionally, as illustrated in FIG. 12B, the processor 12 may also cause the display 54 to display an image G2a indicating the severity “1” of the allergy to “shrimp” as the second image. As illustrated in FIG. 12B, the processor 12 may also cause the display 54 to display an image G2b indicating the severity “2” of the allergy to “egg” as the second image. As illustrated in FIG. 12B, the processor 12 may also cause the display 54 to display an image G2c indicating the severity “4” of the allergy to “wheat” as the second image. The processor 12 may cause the images G2a, G2b, and G2c to be displayed in the same color or in respectively characteristic colors on the display 54.

As illustrated in FIG. 12B, when displaying the second images G2a, G2b, and G2c on the display 54, the processor 12 may cause the second images to be displayed with a mode enabling recognition of the correspondence with the first images G1a, G1b, and G1c, respectively. For example, the processor 12 may cause the second images to be displayed on the display 54 at positions near the respectively corresponding first images. As another example, the processor 12 may cause the second images to be displayed on the display 54 partially overlapping the respectively corresponding first images.

As illustrated in FIG. 12B, when displaying the second images G2a, G2b, and G2c on the display 54, the processor 12 may cause the second images to be displayed with different modes depending on the severity of each allergy. In the example illustrated in FIG. 12B, the second images G2a, G2b, and G2c are displayed such that the area increases with a higher class of each. In this way, the processor 12 may cause the size (area) of the second image displayed on the display 54 to be different according to the severity indicated by the second image. In the present embodiment, the differentiation of the second image depending on the severity of allergy is not limited to the size (area) of the second image displayed on the display 54. For example, in the present embodiment, the shape of the second image may be altered when displaying the second image with a different mode depending on the severity of allergy. As another example, in the present embodiment, a display mode such as a blinking speed of the second image may be altered when displaying the second image with a different mode depending on the severity of allergy.

In this way, in the present embodiment, allergy information may include a severity of allergy of a user who uses the table 30. In this case, the at least one processor 12 may also cause the display device 50 to display the second image indicating the severity of allergy.

According to the third embodiment, a staff member who carries ordered food and drink to a customer can look at the display 54 of the display device 50 placed on the table of the customer to easily recognize allergy information about the customer, including the type and severity of allergy. For instance, in the example illustrated in FIG. 12B, a staff member who carries food and drink to a customer can look at the display 54 of the display device 50 placed on the table of the customer to recognize that the customer is allergic to shrimp, egg, and wheat, and also recognize the severities of the allergies.

On the other hand, in step S52 illustrated in FIG. 11, the processor 12 may change a display mode of the first image corresponding to the type of allergy instead of displaying the second image indicating the severity of allergy on the display 54.

FIG. 12C is a diagram illustrating an example of the display on the display 54 of the display device 50. FIG. 12C is a diagram illustrating the same allergy information as the allergy information illustrated in FIG. 12B, but with a different mode. Consider a situation in which the allergy information about a certain customer includes “shrimp”, “egg”, and “wheat” as types of allergies. Consider a situation in which the allergy information about the customer includes information indicating class 1 for “shrimp”, class 2 for “egg”, and class 4 for “wheat” as the severities of allergies, for example.

In this case, as illustrated in FIG. 12C, when displaying the image G1a indicating “shrimp”, the image G1b indicating “egg”, and the image G1c indicating “wheat” as the first images on the display 54, the processor 12 may also change the display mode of the first images according to the severity of allergy. In the example illustrated in FIG. 12C, the first images G1a, G1b, and G1c are displayed such that the area increases with a higher class of each. In this way, the processor 12 may cause the size (area) of the first image displayed on the display 54 to be different according to the severity of allergy. In the present embodiment, the differentiation of the first image depending on the severity of allergy is not limited to the size (area) of the first image displayed on the display 54. For example, in the present embodiment, the shape of the first image may be altered when displaying the first image with a different mode depending on the severity of allergy. As another example, in the present embodiment, a display mode such as a blinking speed of the first image may be altered when displaying the first image with a different mode depending on the severity of allergy.

The processor 12 may also change the position where the first image is to be displayed according to the severity of allergy. For example, in FIGS. 12B and 12C, the images G1a, G1b, and G1c are displayed in the above order on the display 54, but the processor 12 may also rearrange the first images in order of highest to lowest severity of allergy from left to right (specifically, the order G1c, G1b, G1a from left to right).

In the third embodiment, the display device 50 can, through the display on the display 54, display various allergy information about a customer in a visually recognizable way. In another embodiment, the display device 50 may also present various allergy information about a customer in an aurally recognizable way through the output of sound or speech, instead or in addition to the display on the display 54.

In this way, in the present embodiment, allergy information may include a severity of allergy of a user who uses the table 30. In this case, the at least one processor 12 may also change the display mode of the first image according to the severity of allergy. More specifically, the at least one processor 12 may change at least one selected from the group consisting of the size, shape, and blinking speed of the first image according to the severity of allergy. The at least one processor 12 may also cause the display device 50 to display the second image and the first image in association with one another.

According to the third embodiment, a staff member who carries ordered food and drink to a customer can look at the display 54 of the display device 50 placed on the table of the customer to easily recognize allergy information about the customer, including the type and severity of allergy. For instance, in the example illustrated in FIG. 12C, a staff member who carries food and drink to a customer can look at the display 54 of the display device 50 placed on the table of the customer to recognize that the customer is allergic to shrimp, egg, and wheat, and also recognize the severities of the allergies. Consequently, according to the present embodiment, the risk of serving food and drink containing a specific allergen to an allergic person can be lowered.

The third embodiment above describes a case where the light control device 10 controls the light 20 and also controls the display on the display 54 of the display device 50. However, the display on the display 54 of the display device 50 may also be controlled by the other electronic device 100 instead of the light control device 10, for example.

### Fourth Embodiment

The embodiments above are described under the assumption of a type of business in which a staff member of a catering establishment carries food and drink to the table 30 used by a customer. However, in a buffet-style catering establishment, for example, rather than having a staff member of the catering establishment carry food and drink to the table, a customer may take food and drink on their own from a table where food and drink is served. The light control device 10 according to the fourth embodiment can lower the risk of serving food and drink containing a specific allergen to an allergic person in a buffet-style catering establishment, for example. Hereinafter, the light control device 10 according to the fourth embodiment will be described further. In the following description, a description of content that is the same as the content already described will be simplified or omitted, as appropriate.

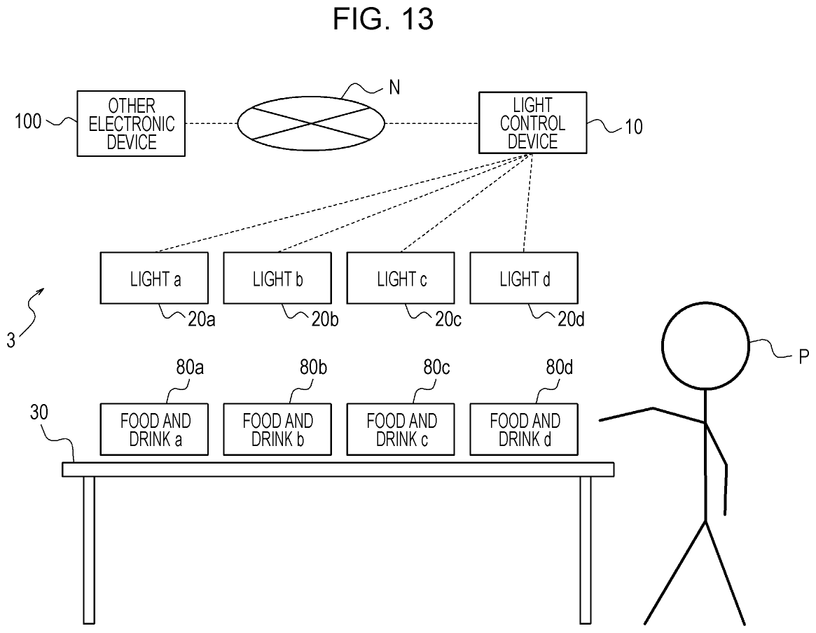

FIG. 13 is a diagram illustrating a configuration of a system according to the fourth embodiment. In the embodiments described above, the light 20 is associated with the table 30. In contrast, as illustrated in FIG. 13, in a system 3 according to the fourth embodiment, the light 20 may be associated with food and drink 80 rather than the table 30. Four types of food and drink 80a to 80d are served on the table 30 illustrated in FIG. 13. The food and drink 80a to 80d may be respectively different menu items, respectively different dishes or drinks, or the like. For example, the food and drink 80a may be seafood curry, the food and drink 80b may be soba, the food and drink 80c may be an omelette, and the food and drink 80d may be milk. In the present disclosure, food and drink such as the food and drink 80a, the food and drink 80b, and the food and drink 80c may simply be referred to as the “food and drink 80” when not being distinguished particularly.

In FIG. 13, a light 20a is associated with the food and drink 80a. The light 20a being associated with the food and drink 80a may mean that the light 20a illuminates the food and drink 80a, for example. The light 20a being associated with the food and drink 80a may mean that the light 20a is positioned near the food and drink 80a, for example. Otherwise, the light 20a may be associated with the food and drink 80a in a variety of configurations. Basically, the light 20a being associated with the food and drink 80a may mean that the light 20a is correlated with the food and drink 80a in some mode.

In the system 3 illustrated in FIG. 13, the light control device 10 may control four lights 20a to 20d. On the other hand, the system 3 may also include four light control devices 10A to 10D that control the four lights 20a to 20d, respectively.

As illustrated in FIG. 13, in the system 3, the food and drink 80a to 80d are assumed to be served on a single table 30. In the system 3 illustrated in FIG. 13, a person P may be a candidate who consumes the food and drink 80. That is, the candidate P illustrated in FIG. 13 may be a person who may possibly eat or drink at least one of the food and drink 80a to 80d.

In the system 3 illustrated in FIG. 13, the candidate P may cause their own allergy information to be stored in advance in a terminal that the candidate P carries. In the system 3 illustrated in FIG. 13, the other electronic device 100 or the light control device 10 may acquire the allergy information about the candidate P in advance. As illustrated in FIG. 13, when the candidate P approaches the table 30, allergy information about the candidate P may be transmitted from the terminal carried by the candidate P to the light control device 10 or the other electronic device 100. If the other electronic device 100 or the light control device 10 acquires allergy information about the candidate P in advance, the candidate P may also carry a means of any type with an identification function, such as a prescribed tag, without carrying a terminal. In this case, when the candidate P approaches the table 30, the other electronic device 100 or the light control device 10 can identify the candidate P and also read allergy information about the candidate P.

In the system 3, when the candidate P comes within a predetermined distance from the food and drink 80, the light control device 10 may control the light 20 associated with the food and drink 80 to indicate whether the food and drink 80 contains a specific allergen. For instance, when the candidate P approaches the food and drink 80a, the light control device 10 may turn the light 20a on or off to indicate whether the food and drink 80a is safe for the candidate P. As an example, assume that the light 20a is already in a predetermined mode (for example, a mode set as an initial setting) and emitting light before the candidate P approaches the food and drink 80a. In such a case, if the candidate P approaches the food and drink 80a, the light control device 10 may change a light emission mode of the light 20a to indicate whether the food and drink 80a is safe for the candidate P.

In this way, in the present embodiment, the light control device 10 may control the light 20 associated with the food and drink 80. In this case, the at least one processor 12 of the light control device 10 may also control the light 20 associated with the food and drink 80 based on allergy information about a candidate who consumes the food and drink 80.

In the present embodiment, the light control device 10 may perform the above control as follows when indicating with the light 20 that food and drink is not safe for the candidate P. For example, the light control device 10 may transmit, to an external device through the communication unit 18, information indicating an allergen (that is, an allergen to the candidate P) associated with the light 20 indicating that the food and drink is not safe for the candidate P and information indicating which food and drink contains the allergen. In this case, the external device may display an image indicating the allergen on a display of the external device and which food and drink contains the allergen, based on the information indicating an allergen contained in the food and drink and the information indicating which food and drink contains the allergen. This arrangement enables the candidate P to choose food and drink more easily.

As an example, the light control device 10 may perform the above control as follows when using the light 20a to indicate that food and drink a is not safe for the candidate P. For example, the light control device 10 transmits, to an external device through the communication unit 18, an identifier (such as an allergen name, for example) indicating an allergen corresponding to the light 20a (that is, the allergen contained in the food and drink a) and an identifier indicating the food and drink a. The external device may be a terminal carried by the candidate P or a display device installed near the table where the food and drink is placed, for example. The identifier indicating the food and drink a may be the name of the food and drink a or the location of the food and drink a, for example.

The external device may display, on a display, the identifier indicating the allergen corresponding to the light 20a together with the name of the food and drink a and the name of the allergen contained in the food and drink a based on the identifier indicating the food and drink a. The external device may also display, on a display, the identifier indicating the allergen corresponding to the light 20a together with an image indicating the location of the food and drink a on the table 30 and the name of the allergen contained in the food and drink a based on the identifier indicating the food and drink a. The light control device 10 may also transmit information indicating an allergen contained in food and drink and information indicating which food and drink contains the allergen upon receiving a signal requesting the information from the external device through the communication unit 18.

In the present embodiment, the light control device 10 may perform the above control as follows when indicating with the light 20 that food and drink is safe for the candidate P. For example, the light control device 10 may transmit, to an external device through the communication unit 18, information indicating that food and drink is safe for the candidate P and information indicating which food and drink is safe. In this case, the external device may display an image indicating that the food and drink is safe for the candidate P on a display of the external device, based on the information indicating that food and drink is safe for the candidate P and the information indicating which food and drink is safe. This arrangement enables the candidate P to choose food and drink more easily.

As an example, the light control device 10 may perform the above control as follows when using the light 20a to indicate that food and drink a is safe for the candidate P. For example, the light control device 10 transmits, to an external device through the communication unit 18, an identifier indicating that the food and drink a is safe for the candidate P and an identifier indicating the food and drink a. The external device may be a terminal carried by the candidate P or a display device installed near the table where the food and drink is placed, for example. The identifier indicating the food and drink a may be the name of the food and drink a or the location of the food and drink a, for example. The external device may display, on a display, the identifier indicating that the food and drink a is safe for the candidate P together with the name of the food and drink a and an image indicating that the food and drink a is safe based on the identifier indicating the food and drink a. The external device may display, on a display, the identifier indicating that the food and drink a is safe for the candidate P together with an image indicating the location of the food and drink a on the table 30 and an image indicating that the food and drink a is safe based on the identifier indicating the food and drink a. The light control device 10 may also transmit information indicating that food and drink is safe for the candidate P and information indicating which food and drink is safe upon receiving a signal requesting the information from the external device through the communication unit 18.

In the present embodiment, the light control device 10 may perform the above control as follows when indicating with the light 20 that all food and drink placed on the table is safe for the candidate P. For example, the light control device 10 may transmit, to an external device through the communication unit 18, information indicating that all food and drink is safe for the candidate P and information indicating the table on which the food and drink is placed. In this case, the external device may display an image indicating that all of the food and drink placed on the table is safe for the candidate P on a display of the external device, based on the information indicating that all food and drink is safe for the candidate P and the information indicating the table on which the food and drink is placed. This arrangement enables the candidate P to choose food and drink more easily.

As an example, the light control device 10 may perform the above control as follows when using the lights 20a to 20d to indicate that food and drink a to d is safe for the candidate P. For example, the light control device 10 transmits, to an external device through the communication unit 18, an identifier indicating that all food and drink is safe for the candidate P and an identifier indicating the table 30. The external device may be a terminal carried by the candidate P or a display device installed near the table where the food and drink is placed, for example. The identifier indicating the table 30 may be a name of the table or an ID of the table, for example. The external device may display an image indicating that all of the food and drink placed on the table 30 is safe for the candidate P on a display, based on the identifier indicating that all food and drink is safe for the candidate P and the identifier indicating the table 30. The light control device 10 may also transmit information indicating that all food and drink is safe for the candidate P and information indicating the table on which the food and drink is placed upon receiving a signal requesting the information from the external device through the communication unit 18.

According to the fourth embodiment, the candidate P attempting to eat the food and drink 80 can look at the light 20 associated with the food and drink 80 to easily know whether the food and drink 80 is safe for the candidate P, for example.

### Fifth Embodiment

In some situations, the candidate P may not know whether food and drink contains an allergen by looking at the food and drink. The light control device 10 according to a fifth embodiment enables the candidate P to easily recognize whether food and drink contains an allergen by looking at the food and drink.

The fifth embodiment may be carried out by the same and/or a similar configuration as the system 3 according to the fourth embodiment described in FIG. 13. In the following description, a description of content that is the same as the fourth embodiment will be simplified or omitted, as appropriate.

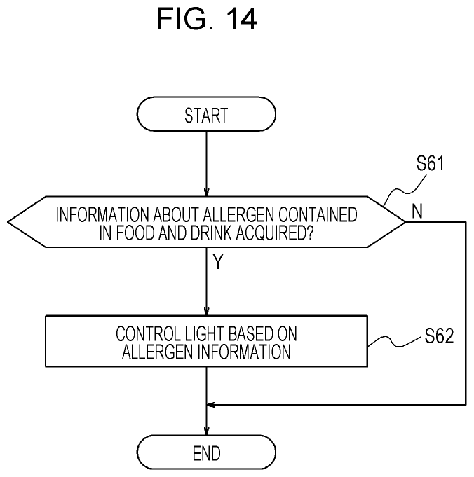

FIG. 14 is a flowchart for describing basic operations by the light control device 10 according to the fifth embodiment.

When the operations illustrated in FIG. 14 are started, the processor 12 of the light control device 10 determines whether information about an allergen contained in the food and drink 80 has been acquired (step S61). In step S61, the information about an allergen contained in the food and drink 80 may be acquired from the other electronic device 100, for example. In step S61, information about an allergen contained in the food and drink 80 may also be acquired from information stored in the storage 16 of the light control device 10 or from information inputted into the other electronic device 100 via the operation unit 110. In step S61, if information about an allergen contained in the food and drink 80 has been acquired, the processor 12 controls the light 20 connected to the light control device 10 based on the acquired allergen information (step S62). The control of the light 20 in step S62 may be the same and/or similar to the control in the embodiments described above, for example.

On the other hand, if allergy information has not been acquired in step S61, the processor 12 may skip step S62 and end the operations illustrated in FIG. 14. If the operations illustrated in FIG. 14 are ended, the processor 12 may start the operations illustrated in FIG. 14 again. In this case, the processor 12 may repeat the operations illustrated in FIG. 14 periodically or aperiodically. The processor 12 may also repeat the operations illustrated in FIG. 14 until allergen information is acquired in step S61.

The “allergen information” that is determined to be acquired or not in step S61 may refer to information pertaining to a specific allergen (antigen that causes an allergy), for example. Specifically, the information pertaining to a specific allergen may refer to information indicating an ingredient selected from among the seven specified ingredients that are required to be labeled under the Food Labeling Standards of the Consumer Affairs Agency of Japan, for example. The information pertaining to a specific allergen may also refer to information indicating an item selected from among items (such as the 21 items for which labeling is recommended, for example) equivalent to the specified ingredients according to the Food Labeling Standards of the Consumer Affairs Agency of Japan, for example.

In this way, in the present embodiment, the light control device 10 may control the light 20 associated with the food and drink 80. In this case, the at least one processor of the light control device 10 may also control the light 20 associated with the food and drink 80 based on information about an allergen contained in the food and drink 80.

According to the fifth embodiment, the candidate P attempting to eat the food and drink 80 can look at the light 20 associated with the food and drink 80 to easily know whether the food and drink 80 is safe for the candidate P, for example.

The embodiments described above are not limited only to being carried out as the light control device 10 included in the systems 1 to 3. For example, the embodiments described above may also be carried out as the other electronic device 100 included in the systems 1 to 3. As another example, the embodiments described above may also be carried out as the light 20 included in the systems 1 to 3. In this way, each of the embodiments described above may be carried out as the light 20 provided with the light control device 10 as described above. The embodiments described above may also be carried out as a system including devices like the light display device 10 and/or the other electronic device 100 included in the systems 1 to 3. The embodiments described above are not limited only to being carried out as devices like the light control device 10, the light 20, and/or the other electronic device 100 included in the systems 1 to 3. For example, the embodiments described above may also be carried out as a method for controlling an electronic device like the light control device 10 included in the systems 1 to 3. As a further example, the embodiments described above may also be carried out as a program to be executed by an electronic device like the light control device 10 included in the systems 1 to 3.

The present disclosure has been described based on the drawings and examples, but note that a person skilled in the art could easily make various modifications or revisions based on the present disclosure. Consequently, it is understood that these modifications or revisions are included in the scope of the present disclosure. For example, the functions and the like included in each function unit may be rearranged in logically non-contradictory ways. Multiple function units or the like may be combined into one, or a function unit may be divided. Each embodiment according to the present disclosure described above is not limited to being carried out exactly according to each embodiment as described, and may be carried out by combining features or omitting some features, as appropriate. In other words, the content of the present disclosure enables a person skilled in the art to make various modifications and revisions based on the present disclosure. Therefore, these modifications or revisions are included in the scope of the present disclosure. For example, in each embodiment, each function unit, means, step, and the like can be added to another embodiment or replaced by each function unit, means, step, and the like of another embodiment in logically non-contradictory ways. In each embodiment, multiple function units, means, steps, and the like can be combined into one, or each function unit, means, step, and the like can be divided. Each embodiment according to the present disclosure described above is not limited to being carried out exactly according to each embodiment as described, and can be carried out by combining features or omitting some features, as appropriate.

For example, the embodiments above are described under the presumption of mainly being provided for use by an allergic person with a food allergy. However, the light control device 10 and/or light 20 according to an embodiment is not limited to being provided for use by an allergic person with a food allergy. The light control device 10 and/or light 20 according to an embodiment may also be provided for use by a person who cannot consume certain food and drink for religious reasons, for example. The light control device 10 and/or light 20 according to an embodiment may also be provided for use by a person with dietary restrictions, such as a person who is pregnant or a person who tends to have high blood pressure, for example. The light control device 10 and/or light 20 according to an embodiment is not limited to allergies and may also accommodate dietary preferences, such as what food and drink a customer likes or dislikes, for example. In cases like the above, the content of the allergy information may simply be inputted or registered from the standpoint of something other than an allergy.

### REFERENCE SIGNS

1, 2, 3 system

10 light control device

12 processor

14 light control circuit

16 storage

18 communication unit

20 light

30 table

40 chair

50 display device

52 processor

54 display

56 storage

58 communication unit

60 operation unit

80 food and drink

100 other electronic device

102 processor

104 display

106 storage

108 communication unit

110 operation unit

112 reading unit

N network

1. A light control device comprising at least one processor configured to control a light associated with a table, wherein
the at least one processor is configured to control the light associated with the table based on allergy information about a user who uses the table.

2. The light control device according to claim 1, wherein
the at least one processor is configured to turn on the light associated with the table based on allergy information about the user who uses the table.

3. The light control device according to claim 1, wherein
the at least one processor is configured to change a light emission mode of the light associated with the table.

4. The light control device according to claim 3, wherein
the at least one processor is configured to change at least one selected from the group consisting of a luminance, a luminous intensity, and an illuminance of the light associated with the table.

5. The light control device according to claim 3, wherein
the at least one processor is configured to change a color of the light associated with the table.

6. The light control device according to claim 3, wherein
the at least one processor is configured to cause the light associated with the table to blink.

7. The light control device according to claim 3, wherein
when the allergy information includes allergy information about a plurality of users who use the table, the at least one processor is configured to change the light emission mode of the light associated with the table differently from when the allergy information includes only allergy information about a single user who uses the table.

8. The light control device according to claim 1, wherein
the allergy information includes a type of allergy of the user who uses the table, and
the at least one processor is configured to control the light associated with the table according to the type of allergy.

9. The light control device according to claim 8, wherein
the at least one processor is configured to change at least one selected from the group consisting of a luminance, a luminous intensity, and an illuminance of the light associated with the table according to the type of allergy.

10. The light control device according to claim 8, wherein
the at least one processor is configured to change a color of the light associated with the table according to the type of allergy.

11. The light control device according to claim 8, wherein
the at least one processor is configured to change a blinking mode of the light associated with the table according to the type of allergy.

12. The light control device according to claim 1, wherein
the allergy information includes a severity of allergy of the user who uses the table, and
the at least one processor is configured to control the light associated with the table according to the severity of allergy.

13. The light control device according to claim 12, wherein
the at least one processor is configured to change at least one selected from the group consisting of a luminance, a luminous intensity, and an illuminance of the light associated with the table according to the severity of allergy.

14. The light control device according to claim 12, wherein
the at least one processor is configured to change a color of the light associated with the table according to the severity of allergy.

15. The light control device according to claim 12, wherein
the at least one processor is configured to change a blinking mode of the light associated with the table according to the severity of allergy.

16. The light control device according to claim 3, wherein
the at least one processor is configured to start execution of control of the light associated with the table at a prescribed time.

17. The light control device according to claim 3, further comprising:
a reception unit configured to receive, from an other electronic device, an allowed signal allowing execution of control of the light associated with the table, wherein
the at least one processor is configured to start execution of the control of the light associated with the table in response to the reception unit receiving the allowed signal.

18. The light control device according to claim 3, further comprising:
a reception unit configured to receive, from an other electronic device, a disallowed signal disallowing execution of control of the light associated with the table, wherein
the at least one processor is configured not to start or stop execution of the control of the light associated with the table in response to the reception unit receiving the disallowed signal.

19. The light control device according to claim 1, wherein
the allergy information includes a type of allergy of the user who uses the table, and
the at least one processor is configured to cause a display device associated with the table to display a first image corresponding to the type of allergy.

20. The light control device according to claim 19, wherein
the allergy information includes a severity of allergy of the user who uses the table, and
the at least one processor is configured to causes the display device to display a second image indicating the severity of allergy.

21. The light control device according to claim 19, wherein
the allergy information includes a severity of allergy of the user who uses the table, and
the at least one processor is configured to changes a display mode of the first image according to the severity of allergy.

22. The light control device according to claim 20, wherein
the at least one processor is configured to cause the display device to display the second image and the first image in association with one another.

23. (canceled)

24. A light control device comprising:
at least one processor configured to control a light associated with a food or drink, wherein
the at least one processor is configured to control the light associated with the food or drink based on information about an allergen contained in the food or drink.

25. (canceled)

26. A method comprising:
controlling a light associated with a table, wherein
the controlling comprises controlling the light associated with the table based on allergy information about a user who uses the table.

27. (canceled)
